(19) United States
(12) Patent Application Publication
(10) Pub. No.: US 2025/0350342 A1
(43) Pub. Date: Nov. 13, 2025

(54) GROUP LEVEL BEAM FAILURE DETECTION REFERENCE SIGNAL ACTIVATION

(71) Applicant: QUALCOMM Incorporated, San Diego, CA (US)

(72) Inventors: Shanyu ZHOU, San Diego, CA (US); Tao LUO, San Diego, CA (US); Ruiming ZHENG, Beijing (CN); Ozcan OZTURK, San Diego, CA (US)

(21) Appl. No.: 18/871,285

(22) PCT Filed: Aug. 2, 2022
(86) PCT No.: PCT/CN2022/109604

§ 371 Date: Dec. 3, 2024

(51) Int. Cl. H04B 7/06; H04W 72/231

(52) U.S. Cl. CPC H04B 7/06964; H04W 72/231

(57) ABSTRACT

Various aspects of the present disclosure generally relate to wireless communication. In some aspects. a user equipment (UE) may receive. from a network node. a configuration of a plurality of beam failure detection reference signal (BFD-RS) sets for a group of cells. The UE may receive. from the network node. a cell group BFD-RS activation medium access control (MAC) control clement (MAC-CE) that activates one or more BFD-RSs. of the plurality of BFD-RS sets. for one or more cells in the group of cells. Numerous other aspects are provided.

### FIELD OF THE DISCLOSURE

Aspects of the present disclosure generally relate to wireless communication and specifically, to techniques and apparatuses for group level beam failure detection (BFD) reference signal (BFD-RS) activation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

Beam failure detection (BFD) is a procedure in which a user equipment (UE) assesses radio link quality on a serving cell by performing measurements of BFD reference signals (BFD-RSs). In some examples, the BFD-RSs for a serving cell may be activated for a UE by a communication transmitted to the UE by a network node. In a case in which the UE is operating with multiple serving cells, separate communications are required for BFD-RS activation on each serving cell, which may result in redundant signaling overhead. Such redundant signaling overhead results in inefficient consumption of network resources, particularly when the number of serving cells for the UE is large, which causes increased traffic latency in the network.

### SUMMARY

Some aspects described herein relate to a user equipment (UE) for wireless communication. The UE may include at least one processor and at least one memory, communicatively coupled with the at least one processor, that stores processor-readable code. The processor-readable code, when executed by the at least one processor, may be configured to cause the user equipment to receive, from a network node, a configuration of a plurality of beam failure detection reference signal (BFD-RS) sets for a group of cells. The processor-readable code, when executed by the at least one processor, may be configured to cause the user equipment to receive, from the network node, a cell group BFD-RS activation medium access control (MAC) control element (MAC-CE) that activates one or more BFD-RSs, of the plurality of BFD-RS sets, for one or more cells in the group of cells.

Some aspects described herein relate to a network node for wireless communication. The network node may include at least one processor and at least one memory, communicatively coupled with the at least one processor, that stores processor-readable code. The processor-readable code, when executed by the at least one processor, may be configured to cause the network node to transmit, to a UE, a configuration of a plurality of BFD-RS sets for a group of cells. The processor-readable code, when executed by the at least one processor, may be configured to cause the network node to transmit, to the UE, a cell group BFD-RS activation MAC-CE that activates one or more BFD-RSs, of the plurality of BFD-RS sets, for one or more cells in the group of cells.

Some aspects described herein relate to a method of wireless communication performed by a UE. The method may include receiving, from a network node, a configuration of a plurality of BFD-RS sets for a group of cells. The method may include receiving, from the network node, a cell group BFD-RS activation MAC-CE that activates one or more BFD-RSs, of the plurality of BFD-RS sets, for one or more cells in the group of cells.

Some aspects described herein relate to a method of wireless communication performed by a network node. The method may include transmitting, to a UE, a configuration of a plurality of BFD-RS sets for a group of cells. The method may include transmitting, to the UE, a cell group BFD-RS activation MAC-CE that activates one or more BFD-RSs, of the plurality of BFD-RS sets, for one or more cells in the group of cells.

Some aspects described herein relate to a non-transitory computer-readable medium that stores a set of instructions for wireless communication by a UE. The set of instructions, when executed by one or more processors of the UE, may cause the UE to receive, from a network node, a configuration of a plurality of BFD-RS sets for a group of cells. The set of instructions, when executed by one or more processors of the UE, may cause the UE to receive, from the network node, a cell group BFD-RS activation MAC-CE that activates one or more BFD-RSs, of the plurality of BFD-RS sets, for one or more cells in the group of cells.

Some aspects described herein relate to a non-transitory computer-readable medium that stores a set of instructions for wireless communication by a network node. The set of instructions, when executed by one or more processors of the network node, may cause the network node to transmit, to a UE, a configuration of a plurality of BFD-RS sets for a group of cells. The set of instructions, when executed by one or more processors of the network node, may cause the network node to transmit, to the UE, a cell group BFD-RS activation MAC-CE that activates one or more BFD-RSs, of the plurality of BFD-RS sets, for one or more cells in the group of cells.

Some aspects described herein relate to an apparatus for wireless communication. The apparatus may include means for receiving, from a network node, a configuration of a plurality of BFD-RS sets for a group of cells. The apparatus may include means for receiving, from the network node, a cell group BFD-RS activation MAC-CE that activates one or more BFD-RSs, of the plurality of BFD-RS sets, for one or more cells in the group of cells.

Some aspects described herein relate to an apparatus for wireless communication. The apparatus may include means for transmitting, to a UE, a configuration of a plurality of BFD-RS sets for a group of cells. The apparatus may include means for transmitting, to the UE, a cell group BFD-RS activation MAC-CE that activates one or more BFD-RSs, of the plurality of BFD-RS sets, for one or more cells in the group of cells.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of beam failure detection (BFD) and beam failure recovery (BFR) in accordance with the present disclosure.

FIG. 5 is a diagram illustrating an example of BFD and BFR for secondary cell (SCell) in accordance with the present disclosure.

FIG. 6 is a diagram illustrating an example of a medium access control (MAC) control element (MAC-CE) for BFD reference signal (BFD-RS) activation for a component carrier (CC) in accordance with the present disclosure.

FIG. 7 is a diagram illustrating an example associated with group level BFD-RS activation in accordance with the present disclosure.

FIG. 8 is a diagram illustrating an example associated with group level BFD-RS activation in accordance with the present disclosure.

FIG. 9 is a diagram illustrating an example cell group BFD-RS activation MAC-CE in accordance with the present disclosure.

FIG. 10 is a diagram illustrating an example cell group BFD-RS activation MAC-CE in accordance with the present disclosure.

FIG. 11 is a flowchart illustrating an example process performed, for example, by a UE that supports group level BFD-RS activation in accordance with the present disclosure.

FIG. 12 is a flowchart illustrating an example process performed, for example, by a network node that supports group level BFD-RS activation in accordance with the present disclosure.

FIG. 13 is a diagram of an example apparatus for wireless communication that supports group level BFD-RS activation in accordance with the present disclosure.

FIG. 14 is a diagram of an example apparatus for wireless communication that supports group level BFD-RS activation in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to group level beam failure detection (BFD) reference signal (BFD-RS) activation for a group of cells serving a user equipment (UE). Some aspects more specifically relate to a cell group BFD-RS activation medium access control (MAC) control element (MAC-CE) that indicates activation of BFD-RSs for a group of cells serving a UE. In some aspects, a UE may receive, from a network node, a configuration of BFD-RS sets for a group of cells, and the UE may receive, from the network node, a cell group BFD-RS activation MAC-CE that activates one or more BFD-RSs, of the BFD-RS sets, for one or more cells in the group of cells. In some aspects, the cell group BFD-RS activation MAC-CE may indicate, for each cell in the group of cells, whether at least one BFD-RS is activated for the cell. In some aspects, the cell group BFD-RS activation MAC-CE may further indicate, for each cell for which at least on BFD-RS is activated, one or more BFD-RSs activated for the cell.

Particular aspects of the subject matter described in this disclosure can be implemented to realize one or more of the following potential advantages. In some examples, the described techniques can be used to reduce signaling overhead for activating BFD-RSs in multiple cells serving a UE. As a result, efficiency in allocating network resource for BFD-RS activation may be increased, resulting in decreased network traffic latency. Furthermore, UE power consumption may be reduced by the UE receiving and decoding a single MAC-CE that activates BFD-RSs for a group of cells, as compared with the UE receiving and decoding a separate MAC-CE for each cell in the group of cells.

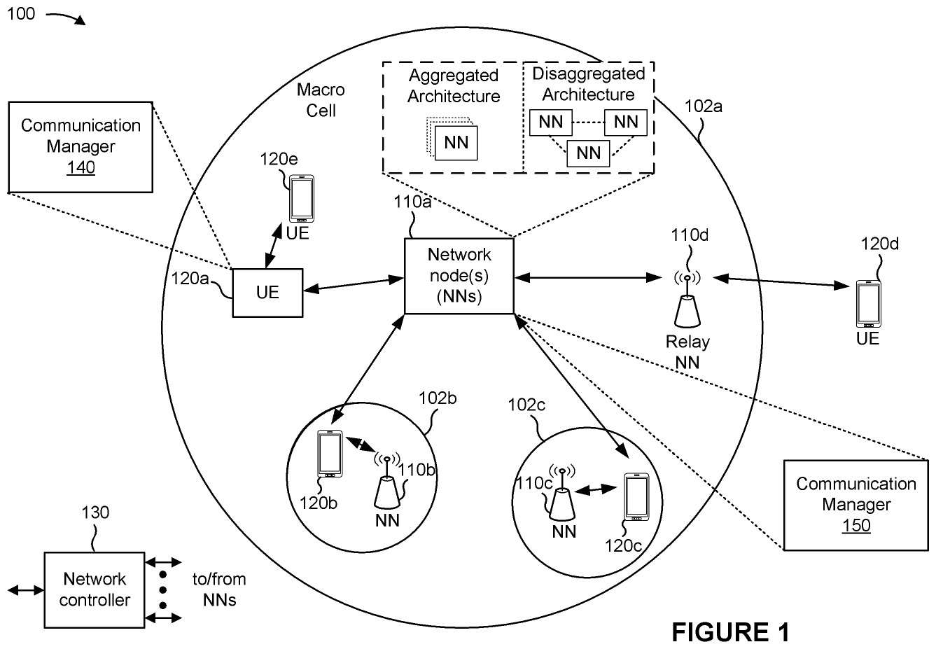

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). Although a portion of FRI is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FRI, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a network node, a configuration of a plurality of BFD-RS sets for a group of cells; and receive, from the network node, a cell group BFD-RS activation MAC-CE that activates one or more BFD-RSs, of the plurality of BFD-RS sets, for one or more cells in the group of cells. Additionally or alternatively, the communication manager 140 may perform one or more other operations described herein.

In some aspects, the network node 110 may include a communication manager 150. As described in more detail elsewhere herein, the communication manager 150 may transmit, to a UE, a configuration of a plurality of BFD-RS sets for a group of cells; and transmit, to the UE, a cell group BFD-RS activation MAC-CE that activates one or more BFD-RSs, of the plurality of BFD-RS sets, for one or more cells in the group of cells. Additionally or alternatively, the communication manager 150 may perform one or more other operations described herein.

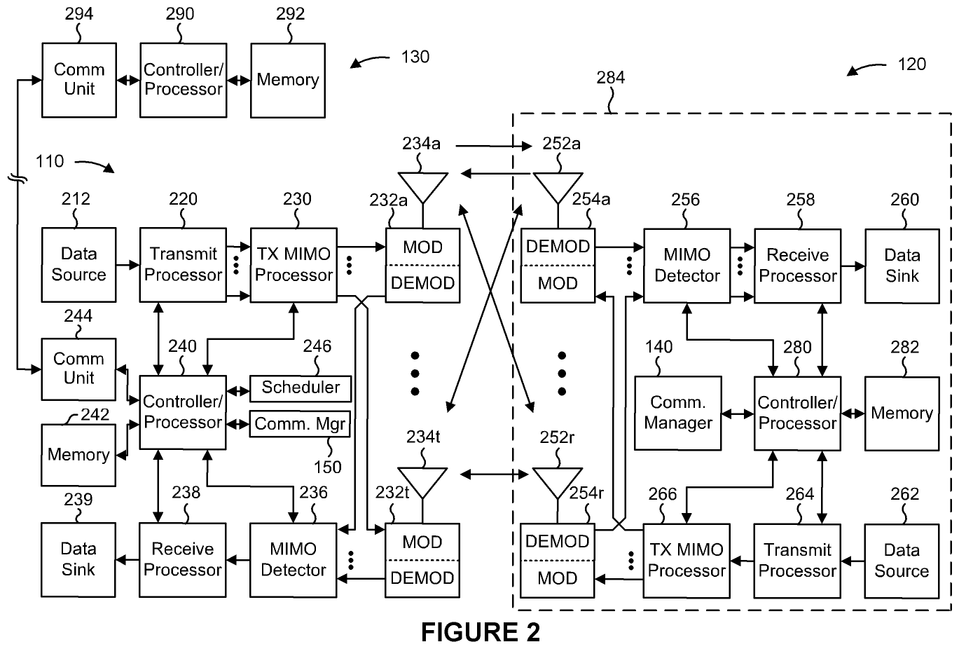

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, 7 modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

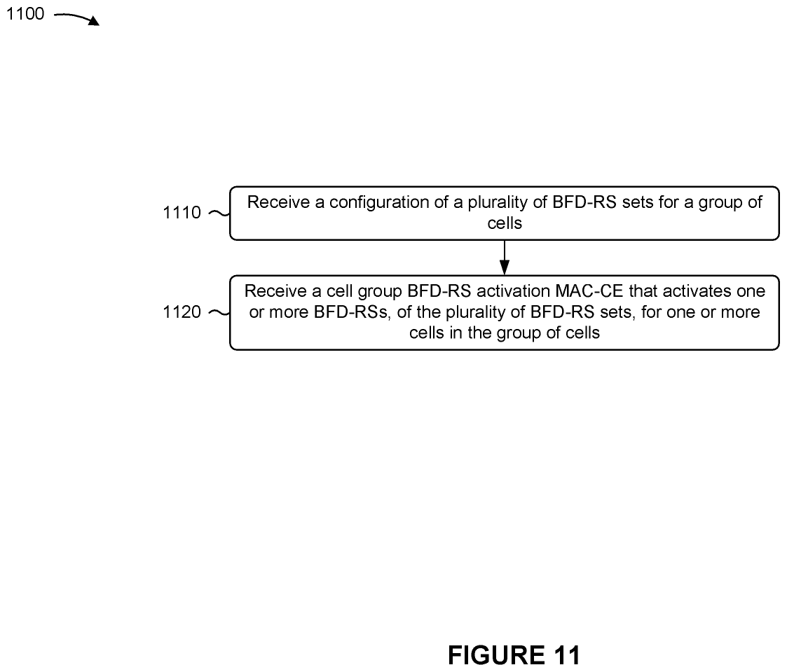

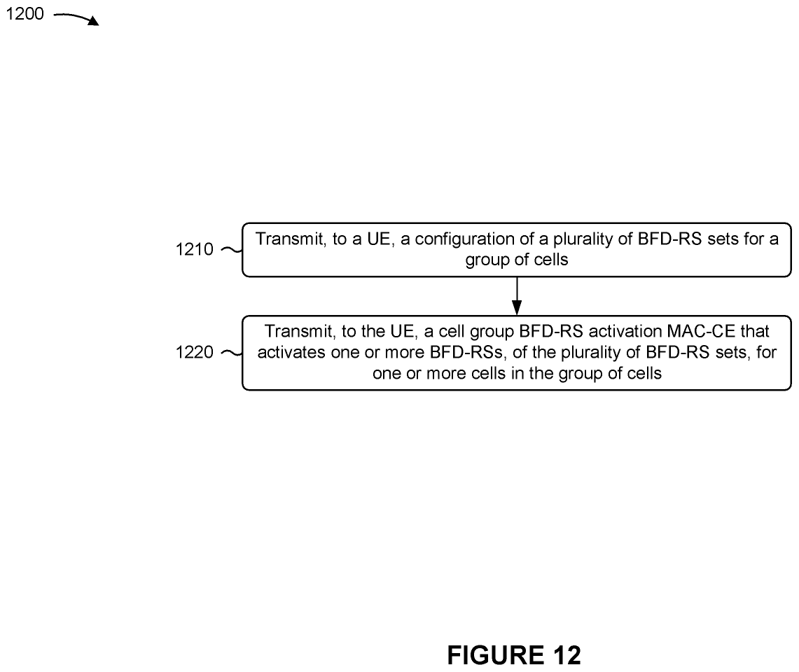

The controller/processor 240 of the network node 110, the controller/processor 280 of the UE 120, or any other component(s) of FIG. 2 may perform one or more techniques associated with group level BFD-RS activation, as described in more detail elsewhere herein. For example, the controller/processor 240 of the network node 110, the controller/processor 280 of the UE 120, or any other component(s) of FIG. 2 may perform or direct operations of, for example, process 1100 of FIG. 11, process 1200 of FIG. 12, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1100 of FIG. 11, process 1200 of FIG. 12, or other processes as described herein. In some examples, executing instructions may include running the instructions, converting the instructions, compiling the instructions, or interpreting the instructions, among other examples.

In some aspects, a UE (for example, the UE 120) includes means for receiving, from a network node, a configuration of a plurality of BFD-RS sets for a group of cells; and means for receiving, from the network node, a cell group BFD-RS activation MAC-CE that activates one or more BFD-RSs, of the plurality of BFD-RS sets, for one or more cells in the group of cells. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (for example, the network node 110) includes means for transmitting, to a UE, a configuration of a plurality of BFD-RS sets for a group of cells; and/or means for transmitting, to the UE, a cell group BFD-RS activation MAC-CE that activates one or more BFD-RSs, of the plurality of BFD-RS sets, for one or more cells in the group of cells. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

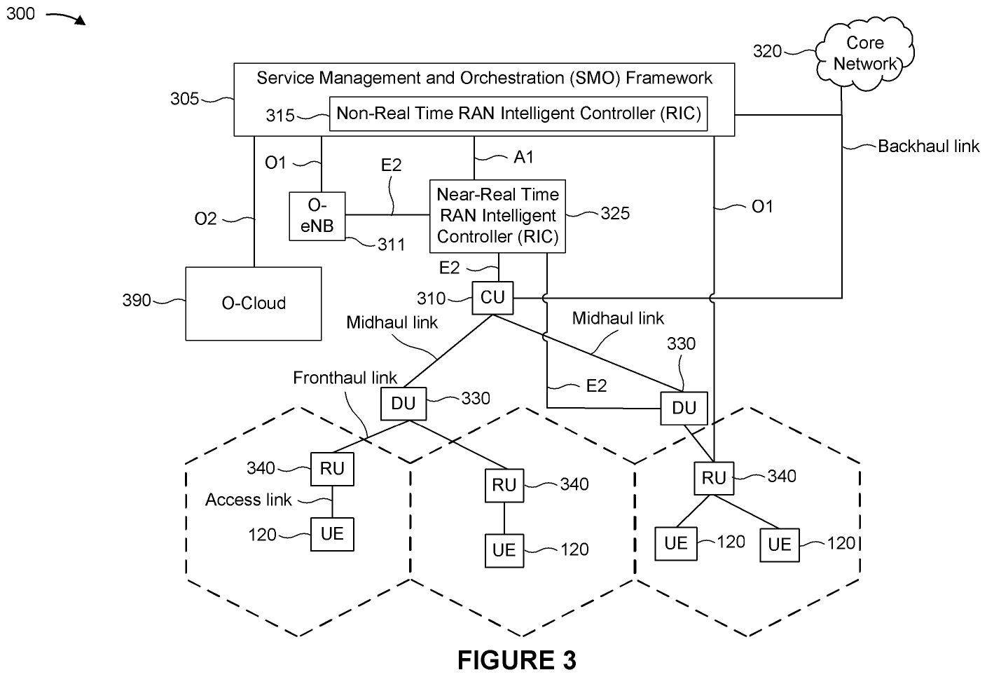

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

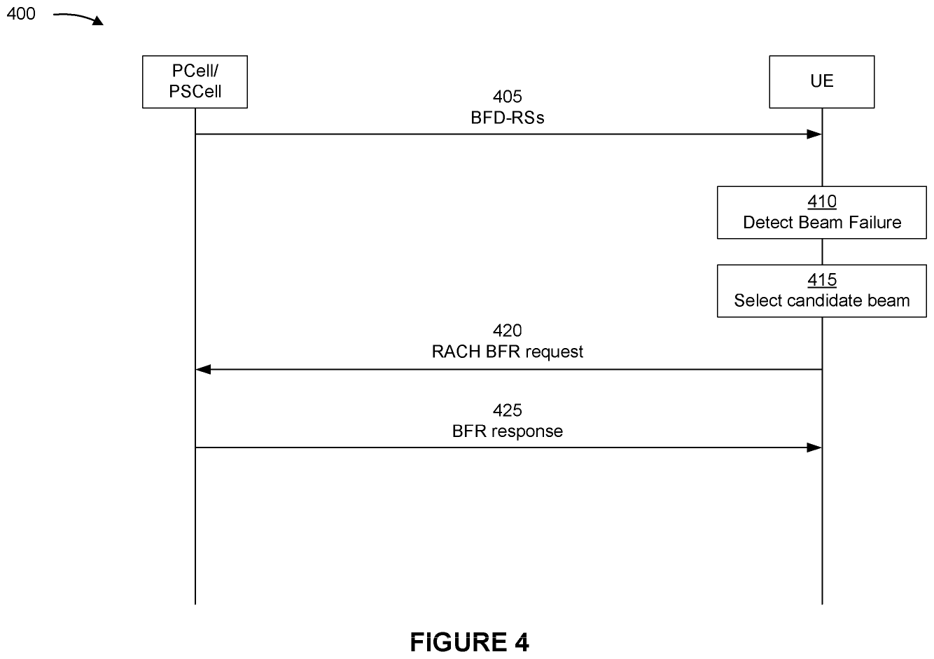

FIG. 4 is a diagram illustrating an example 400 of BFD and beam failure recovery (BFR) in accordance with the present disclosure. Example 400 shows BFD and BFR for a primary component carrier (CC), or primary cell (PCell), configured for a UE. Carrier aggregation is a technology that enables two or more CCs (sometimes referred to as “carriers” or “cells”) to be combined (for example, into a single channel) for a UE to enhance data capacity. In carrier aggregation, a UE may be configured with a primary carrier or PCell and one or more secondary carriers or secondary cells (SCell). In some aspects, the PCell may carry control information for scheduling data communications on the one or more SCells. The BFD and BFR shown in FIG. 4 may be used for the PCell in a case in which carrier aggregation is configured for the UE. In some examples, a UE may be served by multiple cell groups, including a master cell group (MCG) and one or more secondary cell groups (SCGs). In such examples, the BFD and BFR shown in FIG. 4 may also be used for the PCell of the MCG or a PCell of an SCG, which may be referred to as a PSCell.

As shown in FIG. 4, in a first operation 405, a UE may receive (for example, on the PCell or PSCell) BFD-RSs transmitted by a network node. The UE may perform BFD based at least in part on measurements performed on the BFD-RSs. The BFD-RSs may include channel state information (CSI) reference signals (CSI-RSs) transmitted using periodic CSI-RS resources configured via a parameter in an RRC message. In some examples, a BFD-RS set may be configured with up to two BFD-RSs associated with a single antenna port. In a case in which the BFD-RS set is not configured by the network node, reference signal sets indicated by active transmission configuration indicator (TCI) states of control resource sets (CORESETs) monitored by the UE may be used for BFD. In some examples, in a case in which, for an active CORESET, there are two reference signal indices, the reference signal having a quasi co-location (QCL) parameter of type D may be used for BFD.

In a second operation 410, the UE may detect a beam failure based at least in part on the BFD-RSs. The physical layer in the UE may assess radio link quality by measuring RSRP of the BFD-RSs and comparing the RSRP measurements with a threshold (Qout). If the RSRP measurements are less than Qout, the physical (PHY) layer may provide a beam failure indication (for example, an out of service indication) to a higher layer of the UE (for example, the MAC layer), which may increment a beam failure indicator counter. The UE may detect beam failure based at least in part on a threshold number of beam failure indications within a certain time duration (for example, a BFD timer).

In a third operation 415, based at least in part on detecting a beam failure, the UE may perform candidate beam detection to select a candidate beam for BFR. The UE may perform candidate beam detection based at least in part on periodic CSI-RSs and/or synchronization signal blocks (SSBs) configured for a number of beam candidates. In some examples, CSI-RS/SSB resources may be configured for up to 16 beam candidates with corresponding random access preamble indices. Upon a request from a higher layer (for example, the MAC layer), the PHY layer of the UE may detect a reference signal with an RSRP that satisfies a threshold (Qin) and provide the reference signal index to the higher layers.

In a fourth operation 420, the UE may then transmit a random access channel (RACH) BFR request to the network node. For example, the UE may initiate a contention free RACH procedure based on the random access resource (for example, the random access preamble index) associated with the selected reference signal index corresponding to the selected candidate beam.

In a fifth operation 425, the UE may receive a BFR response based at least in part on transmitting the RACH BFR request. The UE may monitor a physical downlink control channel (PDCCH) search space set to detect a PDCCH communication with downlink control information (DCI) format with a cyclic redundancy check (CRC) scrambled by a cell radio network temporary identifier (C-RNTI) or an MCS cell radio network temporary identifier (MCS-C-RNTI), starting a certain number of slots after transmitting the RACH request (for example, starting from slot n+4). In such examples, the UE monitors for a random access response (for example, the PDCCH communication), which is the BFR response. The search space for the PDCCH monitoring may be identified by a recovery search space identifier (ID), and, in some examples, the CORESET associated with an SSS provided by the recovery search space ID may not be used for any other SSS. For PDCCH monitoring in the SSS provided by the recovery search space ID and for corresponding physical downlink shared channel (PDSCH) reception, the UE may us the same QCL parameters as those associated with the reference signal index selected during candidate beam selection (for example, the QCL parameters associated with the selected candidate beam) until the UE receives an activation for a TCI state associated with another beam.

In a case in which the UE receives the PDCCH communication with CRC scrambled by C-RNTI or MCS-C-RNTI within a time window associated with the contention free RACH procedure, the BFR may be complete for the UE. In such examples, after a certain number of symbols (for example, 28 symbols) from a last symbol of the first PDCCH reception, in the search space being monitored by the UE, for which the UE detects a DCI format scrambled by C-RNTI or MCS-C-RNTI, the UE may use the same QCL parameters as those associated with the selected reference signal index for PDCCH monitoring in a CORESET with index 0.

In a case in which the UE does not receive the PDCCH communication with CRC scrambled by C-RNTI or MCS-C-RNTI with the time window associated with the contention free RACH procedure, the UE may initiate a contention-based RACH procedure to transmit the BFR request to the network node. The UE may then monitor the search space for a PDCCH communication with CRC scrambled by C-RNTI or MCS-C-RNTI in response to the contention-based RACH request. In a case, in which the UE does not receive the BFR response in a time window associated with the contention-based RACH procedure, or in a case in which a BFR timer, which starts upon detection of beam failure, expires prior to receiving a BFR response, the UE may declare a radio link failure.

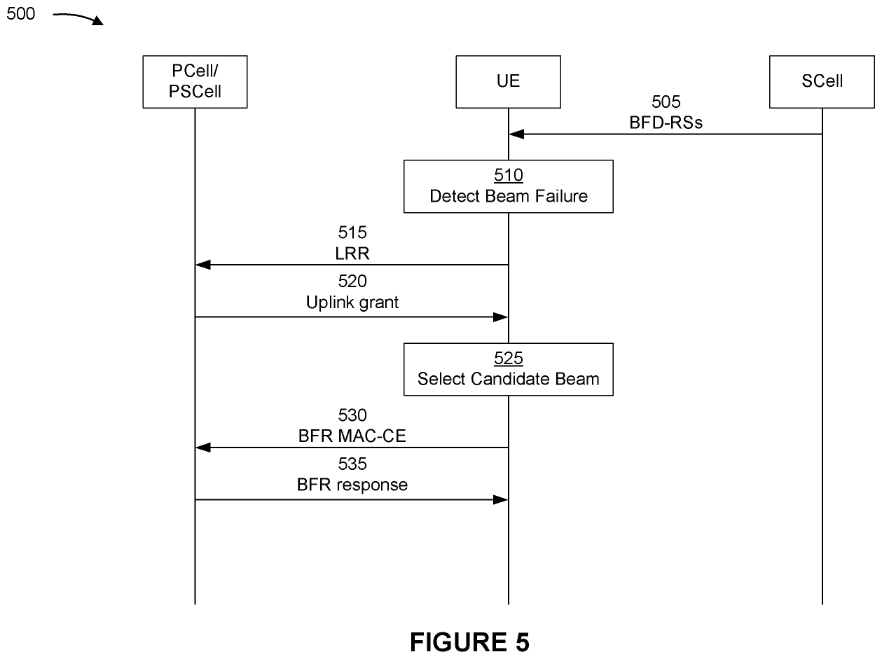

FIG. 5 is a diagram illustrating an example 500 of BFD and BFR for an SCell in accordance with the present disclosure. As described above, an SCell is a secondary CC configured for a UE in carrier aggregation.

As shown in FIG. 5, in a first operation 505, the UE may receive BFD-RSs on the SCell. The UE may perform BFD based at least in part on measurements (for example, RSRP measurements) performed on the BFD-RSs. In a second operation 510, the UE may detect beam failure on the SCell based at least in part on the measurements performed on the BFD-RSs.

In a third operation 515, the UE may transmit, to a network node on the PCell or PSCell, a link recovery request (LRR). In some examples, the UE may transmit the LRR on an SCell configured with a physical uplink control channel (PUCCH) (PUCCH-SCell), in which PUCCH BFR is configured. The LRR may be a scheduling request for requesting an uplink grant to schedule an uplink transmission of a BFR MAC-CE. For example, the LRR may be a PUCCH communication that uses PUCCH format 0 or PUCCH format 1.

In a fourth operation 520, the network node may transmit, to the UE on the PCell, PSCell, or PUCCH-SCell, an uplink grant based at least in part on the LRR. For example, the uplink grant may be included in DCI with CRC scrambled with C-RNTI or MCS-C-RNTI. The uplink grant may schedule a physical uplink shared channel (PUSCH) resource in which the UE may transmit the BFR MAC-CE.

In a fifth operation 525, the UE may perform candidate beam detection to select a candidate beam for BFR. The UE may be configured to receive a reference signal (or reference signal set) on each beam of a list of candidate beams. In some examples, the UE may be configured with up to 64 reference signal resources (corresponding to 64 beams). The UE may receive the reference signals on different beams on the failed SCell or another component carrier in a same frequency band as the failed SCell. In such examples, the UE is not performing a RACH procedure, so the reference signal resources configured for the candidate beams may not be associated with RACH resources. The UE may select a candidate beam for which the RSRP of corresponding reference signals satisfies a threshold (Qin).

In a sixth operation 530, the UE may transmit, to the network node, the BFR MAC-CE. For example, the UE may transmit the BFR MAC-CE using the PUSCH resource scheduled by the uplink grant. Alternatively, in some examples, if the UE has an already scheduled uplink grant, the UE may transmit the BFR MAC-CE in the already scheduled uplink grant without transmitting the LRR or receiving the uplink grant. The BFR MAC-CE may include an indication of the failed SCell (for example, an index of the SCell) and an indication of the selected candidate beam for the SCell. Because the BFR MAC-CE may be transmitted in a scheduled PUSCH resource, the BFR MAC-CE may be transmitted on any component carrier, including the SCell.

In a seventh operation 535, the UE may receive, from the network node, a BFR response. In such examples, the BFR response may be a response to the BFR MAC-CE. The response to the BFR MAC-CE may be an uplink grant to schedule a new transmission (for example, with a toggled new data indicator (NDI)) for a same hybrid automatic repeat request (HARQ) process as the PUSCH transmission carrying the BFR MAC-CE. In a case in which a new beam (for example, the selected beam candidate) is reported in the BFR MAC-CE, after a certain number of symbols (for example, 28 symbols) from the end of the BFR response (for example, the end of the PDCCH communication), all CORESET beams on the failed SCell may be reset to the new beam. In a case in which the failed SCell is a PUCCH-SCell, spatial relationship information for the PUCCH may be configured for the new beam after the certain number of symbols (for example, 28 symbols) from the end of the BFR response. In a case in which the LRR is not transmitted on the failed SCell, PUCCH beams on the failed SCell may be reset to the new beam after the certain number of symbols (for example, 28 symbols) from the end of the BFR response.

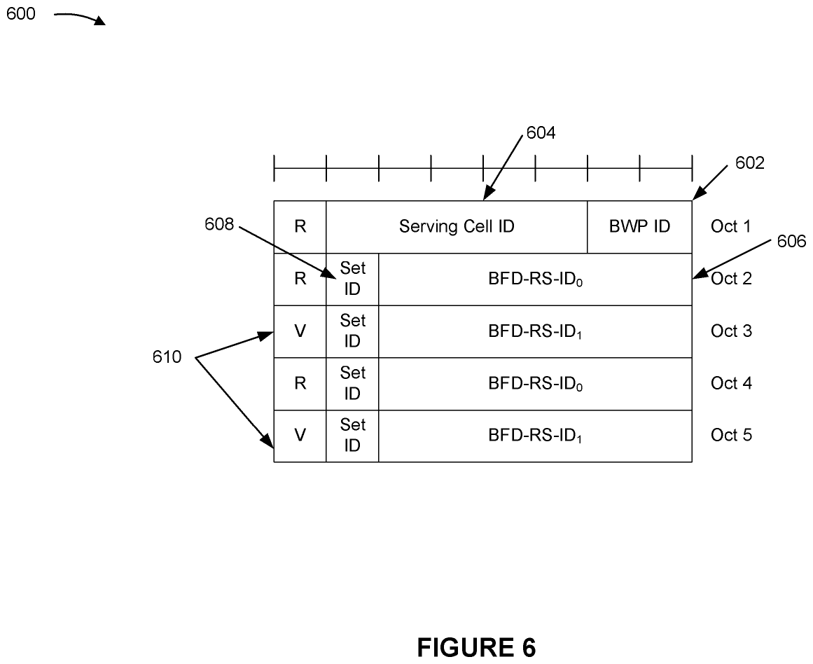

FIG. 6 is a diagram illustrating an example 600 of a MAC-CE for BFD-RS activation for a CC in accordance with the present disclosure.

In some examples, a BFD-RS set configuration that is transmitted to a UE by a network node (for example, via RRC signaling) may configure two BFD-RS sets (for example, failure DetectionSet1 and failureDetectionSet2) for the UE for a CC. Each BFD-RS set may configure BFD-RS resources for a quantity of candidate BFD-RSs. For example, the maximum number of BFD-RSs per BFD-RS set (maxNrofBFD) ResourcePerSet) may be 64. In some examples, a MAC-CE may be used to indicate which BFD-RS resources, from each BFD-RS set, are to be used by the UE for performing BFD. For example, a network node may transmit the MAC-CE to the UE, and the MAC-CE may activate one or two BFD-RSs of the quantity of configured BFD-RSs in each BFD-RS set.

As shown in FIG. 6, the MAC-CE indicates BFD-RS activation in a per CC, per bandwidth part (BWP) granularity. A first octet of bits (October 1) of the MAC-CE includes a BWP ID field 602 that indicates a BWP and a serving cell ID field 604 that indicates a serving cell/CC. The MAC-CE includes four octets (October 2, October 3, October 4, and October 5) that includes fields for indicating activation of up to two BFD-RSs per configured BFD-RS set for the serving cell/CC. October 2-October 5 each include a BFD-RS-ID field 606 (BFD-RS-ID₀ or BRD-RS-ID₁) and a set ID field 608. The set ID field 608 indicates a BFD-RS set of the BFD-RS sets configured for the CC. For example, a value of 0 in the set ID field 608 may indicate a first BFD-RS set, and a value of 1 in the set ID field may indicate a second BFD-RS set. The BFD-RS-ID field 606 indicates an activated BFD-RS from the BFD-RS set indicated in the set ID field 608. In October 2 and October 4, BFD-RS-ID₀ indicates a first activated BFD-RS from the BFD-RS set indicated in the corresponding set ID field 608 in the same octet. In October 3 and October 5, BFD-RS-ID₁ indicates a second activated BFD-RS from the BFD-RS set indicated in the corresponding set ID field 608 in the same octet. October 3 and October 5 each include a field (V) 610 that indicates whether one or two BFD-RSs are activated for the respective BFD-RS set indicated in the set ID field 608. For example, a value of 1 in the V field 610 may indicate that two BFD-RSs are activated for the BFD-RS set indicated in the set ID field 608. That is, the value of 1 in the V field 610 in an octet may indicate that the BFD-RS indicated in the BFD-RS-ID field 606 (BFD-RS-ID₁) in the octet is activated. A value of 0 in the V field 610 may indicate one BFD-RS is activated for the BFD-RS set indicated in the set ID field 608. That is, the value of 0 in the V field 610 in an octet may indicate that the UE may ignore the information included in the BFD-RS-ID field 606 (BFD-RS-ID₁) in the octet. In FIG. 6, “R” represents a reversed bit in an octet

In some examples, the MAC-CE may indicate, for a serving cell/CC, all activated BFD-RSs of the two BFD-RS sets, and the MAC-CE may deactivate all previous activated BFD-RSs for the serving cell/CC upon the UE receiving a new MAC-CE. In some examples, in a case in which a UE cannot support MAC-CE based BFD-RS activation, the BFD-RS set configuration may not configured more than two BFD-RSs per BFD-RS set for the UE.

As described above, a MAC-CE may be used to activate BFD-RSs for a CC/cell for a UE. However, if UE is operating with multiple CCs, such as in a case in which the UE is served by a cell group (for example, a MCG or a SCG) including a PCell and multiple SCells, a separate MAC-CE is transmitted to the UE for BFD-RS activation on each CC/cell. Accordingly, multiple MAC-CEs are needed to activate BFD-RSs on the multiple cells serving the UE, which may result in redundant signaling overhead. Such redundant signaling overhead results in inefficient consumption of network resources, particularly when the number of cells serving the UE is large, which causes increased traffic latency in the network.

Various aspects relate generally to group level BFD-RS activation for a group of cells serving a UE. Some aspects more specifically relate to a cell group BFD-RS activation MAC-CE that indicates activation of BFD-RSs for a group of cells serving a UE. In some aspects, the UE may receive, from a network node, a configuration of a BFD-RS sets for a group of cells, and the UE may receive, from the network node, a cell group BFD-RS activation MAC-CE that activates one or more BFD-RSs, of the BFD-RS sets, for one or more cells in the group of cells. In some aspects, the cell group BFD-RS activation MAC-CE may indicate, for each cell in the group of cells, whether at least one BFD-RS is activated for the cell. In some aspects, the cell group BFD-RS activation MAC-CE may further indicate, for each cell for which at least on BFD-RS is activated, one or more BFD-RSs activated for the cell.

Particular aspects of the subject matter described in this disclosure can be implemented to realize one or more of the following potential advantages. In some examples, the described techniques can be used to reduce signaling overhead for activating BFD-RSs in multiple cells serving a UE. As a result, efficiency in allocating network resource for BFD-RS activation may be increased, resulting in decreased network traffic latency. Furthermore, UE power consumption may be reduced by the UE receiving and decoding a single MAC-CE that activates BFD-RSs for a group of cells, as compared with the UE receiving and decoding a separate MAC-CE for each cell in the group of cells.

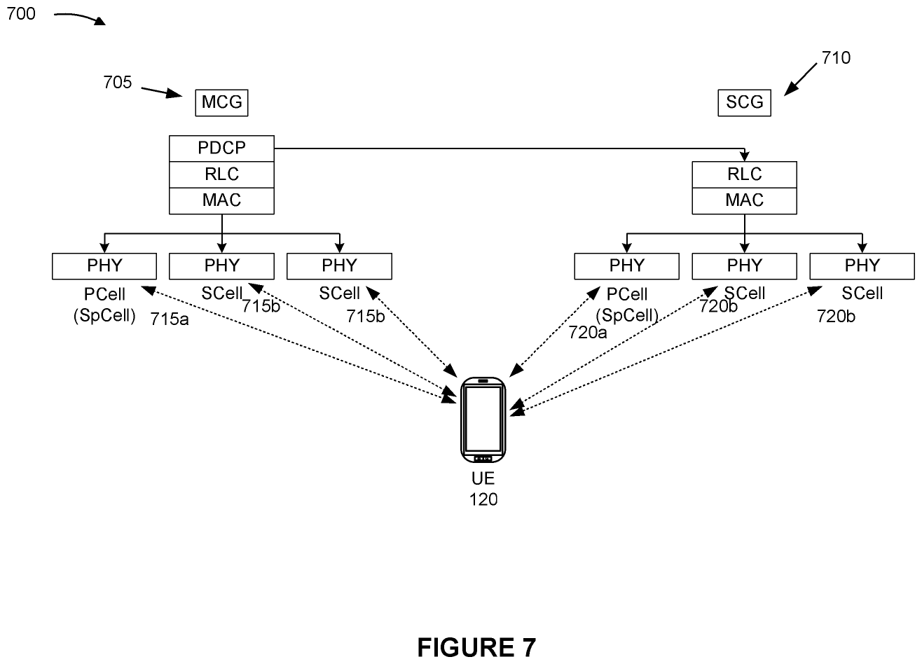

FIG. 7 is a diagram illustrating an example 700 associated with group level BFD-RS activation in accordance with the present disclosure. As shown in FIG. 7, example 700 includes a UE 120 that is served by multiple cell groups, including an MCG 705 and an SCG 710. The UE 120 may communicate with one or more network nodes via the MCG 705 and the SCG 710. For example, the MCG 705 may be implemented by one or more network nodes (for example, one or more CUs, DUs, or RUs), and the SCG 710 may be implemented by one or more network nodes (for example, one or more CUs, DUs, or RUs).

The MCG 705 may include multiple cells 715, including a PCell 715a and one or more SCells 715b. The SCG 710 may include multiple cells 720, including an PSCell 720a and one or more SCells 720b. The PCell 715a and the PSCell 720a may also be referred to a special cells (SpCells). SpCell may refer to a primary cell of any cell group. As shown in FIG. 7, a common PDCP layer may be shared across the MCG 705 and the SCG 710, RLC layers and MAC layers may be maintained and operated separately for the MCG 705 and the SCG 710, and PHY layers may be maintained an operated separately for the cells 715 of the MCG 705 and the cells 720 of the SCG 710.

In some aspects, each cell 715 in the MCG 705 and each cell 720 in the SCG 710 may be associated with multiple BFD-RS sets. For example, cell 715 or 720 may be associated with two BFD-RS sets. In such examples, a BFD-RS set configuration for the UE 120 may indicate, for each cell 715 or 720, two configured BFD-RS sets associated with the cell 715 or 720. In some aspects, each BFD-RS set may include multiple BFD-RSs. For example, each BFD-RS set may include up to N BFD-RSs. In one example, N=64. The BFD-RS set configuration may indicate a configuration of BFD-RS resources (for example, time and frequency resources) for the BFD-RSs included in each BFD-RS set. In some examples, the UE 120 may receive the BFD-RS configuration from a network node via an RRC message.

In some aspects, a network node may transmit, to the UE 120, a cell group BFD-RS activation MAC-CE. The cell group BFD-RS activation MAC-CE is a MAC-CE that indicates BFD-RS activation for a group of cells. For example, the network node may transmit, to the UE 120, a cell group BFD-RS activation MAC-CE that indicates BFD-RS activation for a cell group, such as the MCG 705 or the SCG 710. The cell group BFD-RS activation MAC-CE may indicate, for each cell in the cell group, whether any BFD-RS is activated for the cell. The cell group BFD-RS activation MAC-CE may also indicate, for each cell for which the MAC-CE indicates that any BFD-RS is activated, one or more BFD-RSs for the cell. For example, the cell group BFD-RS activation MAC-CE may indicate, for each cell for which the MAC-CE indicates that any BFD-RS is activated, one or more activated BFD-RSs in each of the BFD-RS sets associated with the cell.

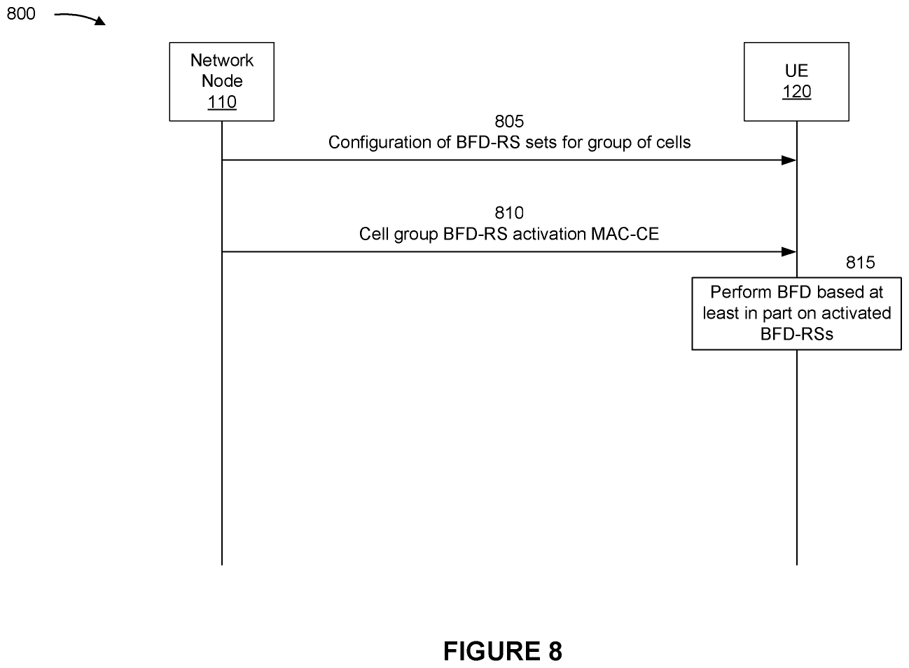

FIG. 8 is a diagram illustrating an example 800 associated with group level BFD-RS activation in accordance with the present disclosure. As shown in FIG. 8, example 800 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

In some aspects, the network node 110 may include multiple network nodes, as described in connection with FIGS. 1 and 3. For example, the multiple network nodes may perform actions, described herein as being performed by the network node 110, according to a functional split (described in connection with FIG. 3). As just one example, configuration actions (for example, RRC signaling or FI signaling) may be performed by a CU of the network node 110, scheduling actions (for example, dynamic signaling or load balancing) may be performed by a DU of the network node 110, and radio communication (for example, direct communication with UEs) may be performed by an RU of the network node 110. In some aspects, the network node 10 may include multiple network nodes associated with different cell groups (for example, an MCG and one or more SCGs) or multiple network nodes associated with different cells (for example, an SpCell and one or more SCells) in a cell group.

As shown in FIG. 8, in a first operation 805, the network node 110 may transmit, to the UE 120, a configuration of BFD-RS sets for a group of cells. The UE 120 may receive, from the network node 110, the configuration of the BFD-RS sets for the group of cells. For example, the network node 110 may transmit the configuration of the BFD-RS sets to the UE 120 in an RRC message (or multiple RRC messages). In some aspects, the group of cells may be a cell group, such as an MCG or an SCG. The cells in the group of cells may also be referred to as CCs, carriers, or serving cells.

In some aspects, the configuration may configure a plurality of BFD-RS sets for the group of cells. In some aspects, the configuration may identify one or more respective BFD-RS sets associated with each cell in the group of cells. For example, the configuration may identify two respective cells associated with each cell in the group of cells. In such examples, for each cell in the group of cells, the configuration may identify a first BFD-RS set associated with the cell and a second BFD-RS set associated with the cell. Each BFD-RS set may include multiple BFD-RSs. For example, each BFD-RS set may include up to N BFD-RSs. In one example, N=64. In some aspects, for each BFD-RS set, the configuration may indicate a configuration of BFD-RS resources (for example, time and frequency resources) for the BFD-RSs included in the BFD-RS set.

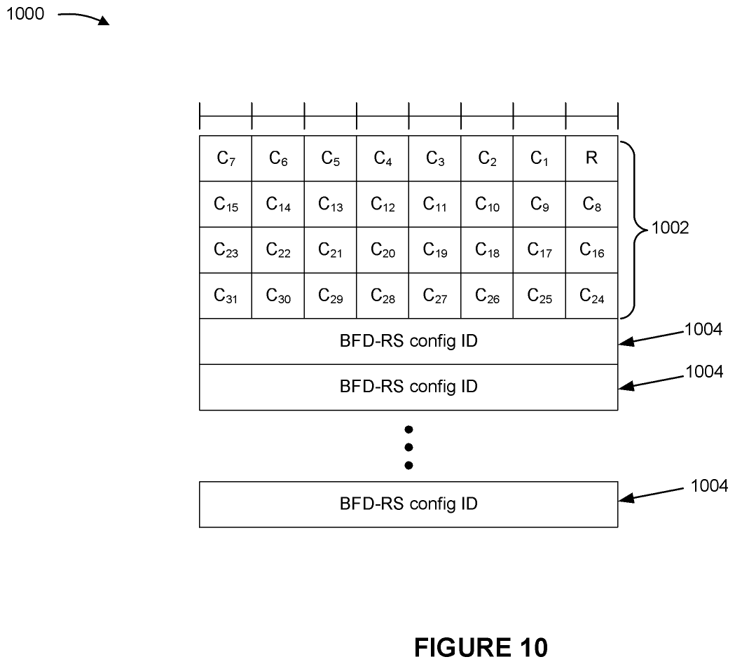

In some aspects, as described in greater detail in connection with FIG. 10, the configuration message that indicates the configuration of the BFD-RS sets for the group of cells may also indicate, for each cell in the group of cells, one or more configured combinations of BFD-RSs and respective BFD-RS configuration IDs associated with the one of more configured combinations of BFD-RSs. In such examples, each of the one or more configured combination of BFD-RSs for a cell may be a combination of BFD-RSs of the one or more BFD-RS sets associated with the cell, and each of the one or more configured combinations of BFD-RSs for a cell may be associated with a respective BFD-RS configuration ID that is indicated in the configuration message.

In some aspects, after the UE 120 receives the configuration message that indicates the configuration of the BFD-RS sets for the group of cells, the UE 120 may transmit an acknowledgement of the configuration to the network node 110. For example, the acknowledgement may be or may be included in an RRC reconfiguration complete message transmitted from the UE 120 to the network node 110.

As further shown in FIG. 8, in a second operation 810, the network node 110 may transmit, to the UE 120, a cell group BFD-RS activation MAC-CE. The UE 120 may receive the cell group BFD-RS activation MAC-CE. The cell group BFD-RS activation MAC-CE may indicate BFD-RS activation for the group of cells. In some aspects, the cell group BFD-RS activation MAC-CE may activate one of more BFD-RSs, of the BFD-RS sets configured for the group of cells, for one or more cells in the group of cells.

In some aspects, the cell group BFD-RS activation MAC-CE may indicate one or more cells, in the group of cells, for which BFD-RS activation is triggered by the cell group BFD-RS activation MAC-CE. As used herein BFD-RS activations is “triggered” for a cell when the cell group BFD-RS activation MAC-CE activates at least one BFD-RS for the cell. In some aspects, the cell group BFD-RS activation MAC-CE may include a set of cell indicator fields that indicate for which cells, in the group of cells, BFD-RS activation is triggered by the cell group BFD-RS activation MAC-CE. For example, the set of cell indicator fields may include a respective cell indicator field for each cell in the group of cells, and each cell indicator field may indicate whether at least one BFD-RS is activated (by cell group BFD-RS activation MAC-CE) the for the respective cell.

In some aspects, the cell group BFD-RS activation MAC-CE may indicate for each cell, in the group of cells, for which BFD-RS activation is triggered (for example, each cell for which the respective cell indicator field indicates that at least on BFD-RS is activated), one or more BFD-RSs that are activated for the cell. For example, for each cell for which BFD-RS activation is triggered, the cell group BFD-RS activation MAC-CE may indicate one or more BFD-RSs in each of the one or more BFD-RS sets associated with the cell. In some aspects, in a case in which each cell is associated with a first BFD-RS set and a second BFD-RS set, the cell group BFD-RS activation MAC-CE may indicate, for each cell for which BFD-RS activation is triggered, one or more (for example, one or two) activated BFD-RSs of the first BFD-RS set and one or more (for example, one or two) activated BFD-RSs of the second BFD-RS set.

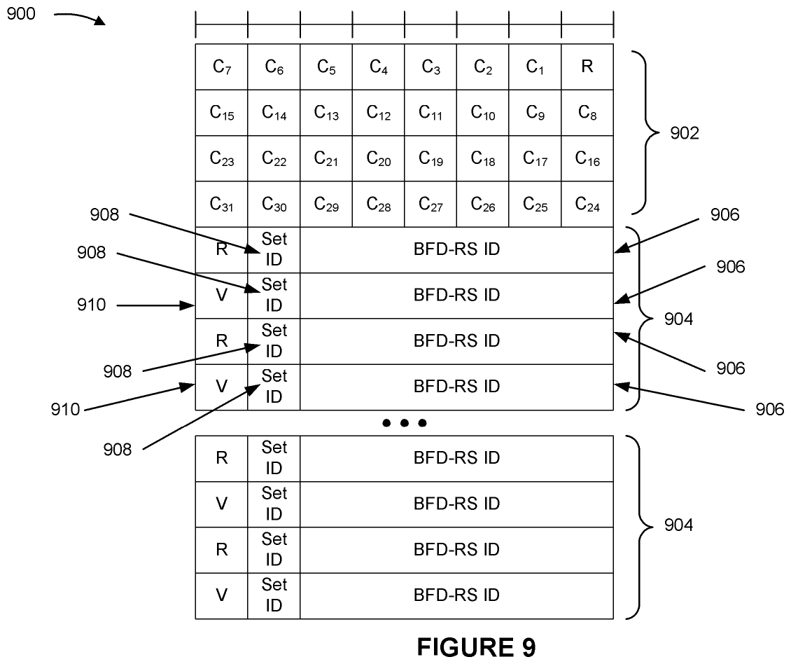

In some aspects, as described in greater detail in connection with FIG. 9, the cell group BFD-RS activation MAC-CE may include, for each cell, in the group of cells, for which the respective cell indicator field indicates that at least one BFD-RS is activated, a respective set of BFD-RS indicator fields. In such examples, the respective set of BFD-RS fields for a cell may include at least one respective BFD-RS indicator field for each of the one or more BFD-RS sets associated with the cell, and each BFD-RS indicator field may identify a respective BFD-RS activated for the cell. For example, the respective set of BFD-RS indicator fields for a cell may include two BFD-RS indicator fields that for a first BFD-RS set associated with the cell and two BFD-RS indicator fields for a second BFD-RS set associated with the cell.

In some aspects, as described in greater detail in connection with FIG. 10, the cell group BFD-RS activation MAC-CE may include, for each cell, in the group of cells, for which the respective cell indicator field indicates that at least one BFD-RS is activated, an indication of a respective BFD-RS configuration ID. In such examples, the respective BFD-RS configuration ID for a cell indicates a combination of one or more BFD-RSs, of the one or more BFD-RS sets associated with the cell, that are activated for the cell. For example, the configuration of the BFD-RS sets may indicate, for each cell in the group of cells, one or more combinations of BFD-RSs, of the one or more BFD-RS sets associated with the cell, that are configured for the cell. In such examples, the respective BFD-RS configuration ID for a cell may correspond to a combination of BFD-RSs of the one or more combinations of BFD-RSs that are configured for the cell.

In some examples, the cell group BFD-RS activation MAC-CE may indicate, for the group of cells, all activated BFD-RSs for the cells in the group of cells. In some aspects, the cell group BFD-RS activation MAC-CE may deactivate all previous activated BFD-RSs for all cells in the group of cells upon the UE 120 receiving the cell group BFD-RS activation MAC-CE. For example, when the UE 120 receives a new cell group BFD-RS activation MAC-CE, the new cell group BFD-RS activation MAC-CE may deactivate all previous activated BFD-RSs indicated in a previous cell group BFD-RS activation MAC-CE.

As further shown in FIG. 8, in a third operation 815, the UE 120 may perform BFD based at least in part on the activated BFD-RSs indicated by the cell group BFD-RS activation MAC-CE. In some aspects, the UE 120 may perform BFD on each cell, in the group of cells, for which the cell group BFD-RS activation MAC-CE activates one or more BFD-RSs, using the one or more BFD-RSs activated for the cell. In such examples, a PHY layer in the UE 120 may assess radio link quality on a cell by measuring RSRP of the activated BFD-RSs for the cell and comparing the RSRP measurements with a threshold (Qout). If the RSRP measurements are less than Qout, the PHY layer may provide a beam failure indication to a higher layer of the UE (for example, the MAC layer), which may increment a beam failure indicator counter. The UE may detect beam failure for a cell based at least in part on a threshold number of beam failure indications within a certain time duration (for example, a time duration associated with a BFD timer).

FIG. 9 is a diagram illustrating an example cell group BFD-RS activation MAC-CE 900 in accordance with the present disclosure. As shown in FIG. 9, the cell group BFD-RS activation MAC-CE 900 may include a set of cell indicator fields 902. In some aspects, the set of cell indicator fields 902 may include a respective cell indicator field Cᵢ for each cell in the group of cells. Each cell indicator field Cᵢ may indicate whether at least one BFD-RS is activated for the respective cell. In some aspects, each cell indicator field Cᵢ may include a first value (for example, Cᵢ=1) that indicates that at least one BFD-RS is activated for the respective cell or a second value (for example, Cᵢ=0) that indicates that no BFD-RS is activated for the respective cell. In some aspects, each cell indicator field Cᵢ may be a one bit field, and the set of cell indicator fields 902 may include a quantity of cell indicator fields Cᵢ that correspond to a possible quantity of cells in a cell group. For example, as shown in FIG. 9, the set of cell indicator fields 902 may include four octets of cell indicator fields Cᵢ corresponding to a possible quantity of 32 cells in a cell group. In some aspects, a first cell indicator field in a first octet may correspond to a PCell/SpCell of a cell group, and the first cell indicator field in the first octet may be a reserved bit (indicated by “R” in FIG. 9), because the UE 120 may expect the cell group BFD-RS activation MAC-CE 900 to indicate one or more activated BFD-RSs for the PCell/SpCell without an explicit indication in the respective cell indicator field.

As further shown in FIG. 9, the cell group BFD-RS activation MAC-CE 900 may include a respective set of BFD-RS indicator fields 904 for each cell, in the group of cells, for which the respective cell indicator field Cᵢ indicates that at least one BFD-RS is activated. For example, the cell group BFD-RS activation MAC-CE 900 may include a respective set of BFD-RS indicator fields 904 for each cell for which Cᵢ=1. In some aspects, the respective set of BFD-RS indicator fields 904, for each cell with Cᵢ=1, may include a first BFD-RS indicator field that indicates a first BFD-RS of a first BFD-RSBFD-RS set associated with the cell, a second BFD-RS indicator field that indicates a second BFD-RS of the first BFD-RS set, a third BFD-RS indicator field that indicates a third BFD-RS of a second BFD-RS set associated with the cell, and a fourth BFD-RS field that indicates a fourth BFD-RS of the second BFD-RS set. For example, as shown in FIG. 9, the respective set of BFD-RS indicator fields 904, for each cell with Cᵢ=1, may include four octets of BFD-RS indicator fields, and each octet may include a BFD-RS ID field 906 and a set ID field 908. The set ID field 908 may indicate a BFD-RS set of the BFD-RS sets configured for the cell. For example, a value of 0 in the set ID field 908 may indicate the first BFD-RS set associated with the cell, and a value of 1 in the set ID field may indicate the second BFD-RS set associated with the cell. Each BFD-RS ID field 906 may include a respective BFD-RS ID that indicates an activated BFD-RS of the BFD-RS set indicated in the set ID field 908 in the same octet.

As further shown in FIG. 9, in some aspects, the respective set of BFD-RS indicator fields 904, for each cell with Cᵢ=1, the second octet and the fourth octet may each include a field (V) 910 that indicates whether a single BFD-RS or two BFD-RSs are activated for the respective BFD-RS set indicated in the set ID fields 908 in that octet. For example, a first value (for example, a value of 1) in the V field 910 in an octet may indicate that two BFD-RSs of the BFD-RS set indicated in the set ID field 908 in the octet are activated. In such examples, the first value (for example, the value of 1) in the V field 910 in an octet may indicate that the BFD-RS indicated in the BFD-RS ID field 906 in the octet is activated. A second value (for example, a value of 0) in the V field 910 in an octet may indicate that one BFD-RS of the BFD-RS set indicated in the set ID field 908 in the octet is activated. In such examples, the second value (for example, the value of 0) in the V field 910 in an octet may indicate that the UE 120 may ignore the information included in the BFD-RS ID field 906 in the octet.

In some aspects, the respective sets of BFD-RS indicator fields 904 for the cells with Cᵢ=1 may be included in the cell group BFD-RS activation MAC-CE 900 in an order based at least in part on the cell index (i) of the corresponding cells with Cᵢ=1. For example, the respective sets of BFD-RS indicator fields 904 for the cells with Cᵢ=1 may be included in the cell group BFD-RS activation MAC-CE 900 in an increasing order of the corresponding cell index i.

FIG. 10 is a diagram illustrating an example cell group BFD-RS activation MAC-CE 1000 in accordance with the present disclosure. As shown in FIG. 10, the cell group BFD-RS activation MAC-CE 1000 may include a set of cell indicator fields 1002. In some aspects, the set of cell indicator fields 1002 may include a respective cell indicator field Cᵢ for each cell in the group of cells. Each cell indicator field Cᵢ may indicate whether at least one BFD-RS is activated for the respective cell. In some aspects, each cell indicator field Cᵢ may include a first value (for example, Cᵢ=1) that indicates that at least one BFD-RS is activated for the respective cell or a second value (for example, Cᵢ=0) that indicates that no BFD-RS is activated for the respective cell. In some aspects, each cell indicator field Cᵢ may be a one bit field, and the set of cell indicator fields 1002 may include a quantity of cell indicator fields Cᵢ that correspond to a possible quantity of cells in a cell group. For example, as shown in FIG. 10, the set of cell indicator fields 1002 may include four octets of cell indicator fields (', corresponding to a possible quantity of 32 cells in a cell group. In some aspects, a first cell indicator field in a first octet may correspond to a PCell/SpCell of a cell group, and the first cell indicator field in the first octet may be a reserved bit (indicated by “R” in FIG. 10), because the UE 120 may expect the cell group BFD-RS activation MAC-CE 1000 to indicate one or more activated BFD-RSs for the PCell/SpCell without an explicit indication in the respective cell indicator field.

As further shown in FIG. 10, the cell group BFD-RS activation MAC-CE 1000 may include a respective BFD-RS configuration ID 1004 for each cell, in the group of cells, for which the respective cell indicator field Cᵢ indicates that at least one BFD-RS is activated. For example, the cell group BFD-RS activation MAC-CE 1000 may include a respective BFD-RS configuration ID field 1004 for each cell for which Cᵢ=1. The respective BFD-RS configuration ID field 1004, for each cell with Cᵢ=1, may indicate a combination of one or more BFD-RSs, of the one or more BFD-RS sets associated with the cell, that are activated for the cell. In some aspects, the respective BFD-RS configuration ID field 1004, for each cell with Cᵢ=1, may include a BFD-RS configuration ID that corresponds to a combination of BFD-RSs of a one or more combinations of BFD-RSs that are configured for the cell. In some aspects, the configuration of the BFD-RS sets for the group of cells may include, for each cell in the group of cells, configuration information that indicates one or more combinations of BFD-RSs configured for the cell. In such examples, for each cell, the one or more combinations of BFD-RSs configured for the cell may be one or more configurations of BFD-RSs in the one or more BFD-RSs associated with the cell. For example, each of the one or more combinations of BFD-RSs configured for a cell may include a combination of one or more (for example, one or two) BFD-RSs from each of a first BFD-RS set and a second BFD-RS set associated with the cell. For each cell in the group of cells, each combination of BFD-RSs, of the one or more combinations of BFD-RSs configured for the cell, may be associated with corresponding BFD-RS configuration ID. In some aspects, the configuration information that indicates the one or more combinations of BFD-RSs configured for each cell may be transmitted to the UE 120 in a separate configuration (for example, via one or more separate RRC messages) from the configuration of the BFD-RS sets for the group of cells.

In some aspects, for each cell in the group of cells, the configuration information that indicates the one or more combinations of BFD-RSs configured for the cell may include, for each combination of BFD-RSs configured for the cell, indications of multiple BFD-RS sets (for example, the multiple BFD-RS sets associated with the cell) and indications of one or more BFD-RSs, in each of the multiple BFD-RS sets, that are included in the combination of BFD-RSs. In such examples, the configuration information for each cell may specify each combination of BFD-RSs for the cell as a combination of BFD-RS sets and corresponding BFD-RSs in the BFD-RS sets. For example, the configuration information for a cell may indicate that a first configuration ID (Config ID1) corresponds to: BFD-RS set 1 {BFD-RS ID1, BFD-RS ID2}, BFD-RS set 2 {BFD-RS ID3, BFD-RS ID4}, and a second configuration ID (Config ID2) corresponds to: BFD-RS set 1 {BFD-RS ID1, BFD-RS ID4}, BFD-RS set 2 {BFD-RS ID6, BFD-RS ID7}.

In some aspects, the configuration information that indicates the one or more combinations of BFD-RSs configured for each cell in the group of cells may include configuration information that indicates the BFD-RS sets and BFD-RSs for a reference combination of BFD-RSs that is configured for a reference cell in the group of cells. For example, the reference cell may be the SpCell in a cell group, such as an MCG or an SCG. In some aspects, a delta configuration, based at least in part on the reference combination of BFD-RSs, may be used to indicate the configuration of the one or more combinations of BFD-RSs for each cell, other than the reference cell, in the group of cells. For example, the configuration information that indicates the one or more combinations of BFD-RSs configured for each cell in the group of cells may include, for each cell, other than the reference cell, respective configuration information that indicates one or more respective differences between each of the one or more combinations of BFD-RSs that are configured for the cell and the reference combination of BFD-RSs that is configured for the reference cell. In this way, a size of the RRC configuration message may be reduced, as compared with including configuration information that specifies the combinations of BFD-RS sets and corresponding BFD-RSs for each combination of BFD-RSs configured for each cell in the group of cells.

In some aspects, the respective BFD-RS configuration ID fields 1004 for the cells with Cᵢ=1 may be included in the cell group BFD-RS activation MAC-CE 1000 in an order based at least in part on the cell index (i) of the corresponding cells with Cᵢ=1. For example, the respective BFD-RS configuration ID fields 1004 for the cells with Cᵢ=1 may be included in the cell group BFD-RS activation MAC-CE 1000 in an increasing order of the corresponding cell index i.

FIG. 11 is a flowchart illustrating an example process 1100 performed, for example, by a UE that supports group level BFD-RS activation in accordance with the present disclosure. Example process 1100 is an example where the UE (for example, UE 120) performs operations associated with group level BFD-RS activation.

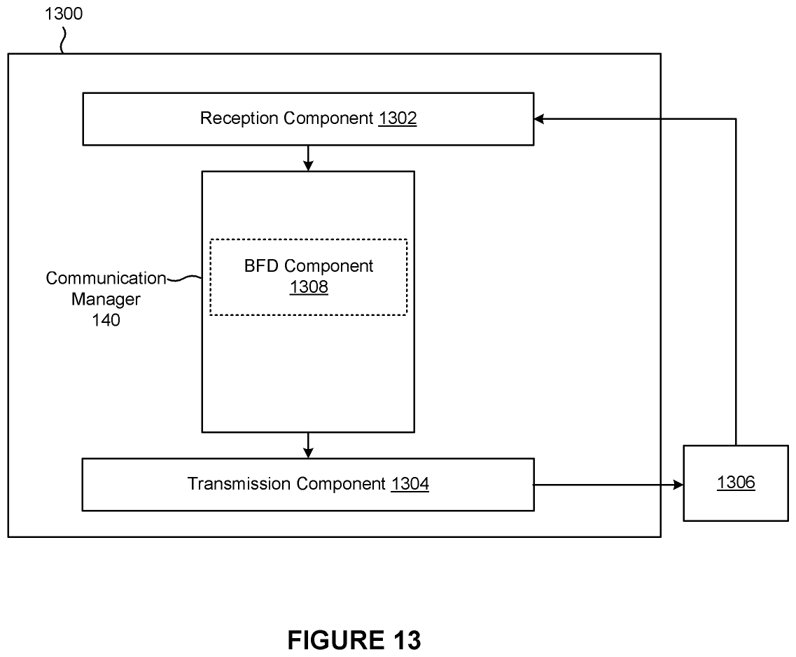

As shown in FIG. 11, in some aspects, process 1100 may include receiving, from a network node, a configuration of a plurality of BFD-RS sets for a group of cells (block 1110). For example, the UE (such as by using communication manager 140 or reception component 1302, depicted in FIG. 13) may receive, from a network node, a configuration of a plurality of BFD-RS sets for a group of cells, as described above.

As further shown in FIG. 11, in some aspects, process 1100 may include receiving, from the network node, a cell group BFD-RS activation MAC-CE that activates one or more BFD-RSs, of the plurality of BFD-RS sets, for one or more cells in the group of cells (block 1120). For example, the UE (such as by using communication manager 140 or reception component 1302, depicted in FIG. 13) may receive, from the network node, a cell group BFD-RS activation MAC-CE that activates one or more BFD-RSs, of the plurality of BFD-RS sets, for one or more cells in the group of cells, as described above.

Process 1100 may include additional aspects, such as any single aspect or any combination of aspects described below or in connection with one or more other processes described elsewhere herein.

In a first additional aspect, the configuration identifies, for each cell in the group of cells, one or more respective BFD-RS sets, of the plurality of BFD-RS sets, associated with the cell.

In a second additional aspect, alone or in combination with the first aspect, the cell group BFD-RS activation MAC-CE includes a set of cell indicator fields including a respective cell indicator field for each cell in the group of cells, each cell indicator field, in the set of cell indicator fields, indicating whether at least one BFD-RS is activated for the respective cell.

In a third additional aspect, alone or in combination with one or more of the first and second aspects, each cell indicator field in the set of cell indicator fields includes a first value that indicates that at least one BFD-RS is activated for the respective cell or a second value that indicates that no BFD-RS is activated for the respective cell.

In a fourth additional aspect, alone or in combination with one or more of the first through third aspects, the cell group BFD-RS activation MAC-CE further includes, for each cell, in the group of cells, for which the respective cell indicator field indicates that at least one BFD-RS is activated, a respective set of BFD-RS indicator fields that includes at least one respective BFD-RS indicator field for each of the one or more BFD-RS sets associated with the cell, each BFD-RS indicator field identifying a respective BFD-RS activated for the cell.

In a fifth additional aspect, alone or in combination with one or more of the first through fourth aspects, for each cell in the group of cells, the one or more BFD-RSs sets associated with the cell include a first BFD-RS set associated with the cell and a second BFD-RS set associated with the cell, and, for each cell, in the group of cells, for which the respective cell indicator field indicates that at least one BFD-RS is activated, the respective set of BFD-RS indicator fields includes a first BFD-RS indicator field that indicates a first BFD-RS of the first BFD-RS set, a second BFD-RS indicator field that indicates a second BFD-RS of the first BFD-RS set, a third BFD-RS indicator field that indicates a third BFD-RS of the second BFD-RS set, and a fourth BFD-RS field that indicates a fourth BFD-RS of the second BFD-RS set.

In a sixth additional aspect, alone or in combination with one or more of the first through fifth aspects, for each cell, in the group of cells, for which the respective cell indicator field indicates that at least one BFD-RS is activated, the respective set of BFD-RS indicator fields includes a respective indication, for each of the first BFD-RS set and the second BFD-RS set, of whether a single BFD-RS of the respective BFD-RS set is activated or two BFD-RSs of the respective BFD-RS set are activated.

In a seventh additional aspect, alone or in combination with one or more of the first through sixth aspects, the cell group BFD-RS activation MAC-CE further includes, for each cell, in the group of cells, for which the respective cell indicator field indicates that at least one BFD-RS is activated, an indication of a respective BFD-RS configuration identifier that indicates a combination of one or more BFD-RSs, of the one or more BFD-RS sets associated with the cell, that are activated for the cell.

In an eighth additional aspect, alone or in combination with one or more of the first through seventh aspects, the configuration indicates, for each cell in the group of cells, one or more combinations of BFD-RSs, of the one or more BFD-RS sets associated with the cell, that are configured for the cell, and, for each cell, in the group of cells, for which the respective cell indicator field indicates that at least one BFD-RS is activated, the respective BFD-RS configuration identifier corresponds to a combination of BFD-RSs of the one or more combinations of BFD-RSs that are configured for the cell.

In a ninth additional aspect, alone or in combination with one or more of the first through eighth aspects, the configuration includes, for each combination of the one or more combinations of BFD-RSs that are configured for each cell in the group of cells, indications of multiple BFD-RS sets of the plurality of BFD-RS sets and indications of one or more BFD-RSs, in each of the multiple BFD-RS sets, that are included in the combination.

In a tenth additional aspect, alone or in combination with one or more of the first through ninth aspects, the configuration includes, for a reference cell of the group of cells, configuration information that indicates BFD-RS sets, of the plurality of BFD-RS sets, and BFD-RSs for a reference combination of BFD-RSs that is configured for the reference cell, and the configuration includes, for each cell, other than the reference cell, of the group of cells, respective configuration information that indicates one or more respective differences between each of the one or more combinations of BFD-RSs that are configured for the cell and the reference combination of BFD-RSs that is configured for the reference cell.

In an eleventh additional aspect, alone or in combination with one or more of the first through tenth aspects, process 1100 includes performing beam failure detection based at least in part on the one or more BFD-RSs activated for the one or more cells in the group of cells.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, by a network node that supports group level BFD-RS activation in accordance with the present disclosure. Example process 1200 is an example where the network node (for example, network node 110) performs operations associated with group level BFD-RS activation.

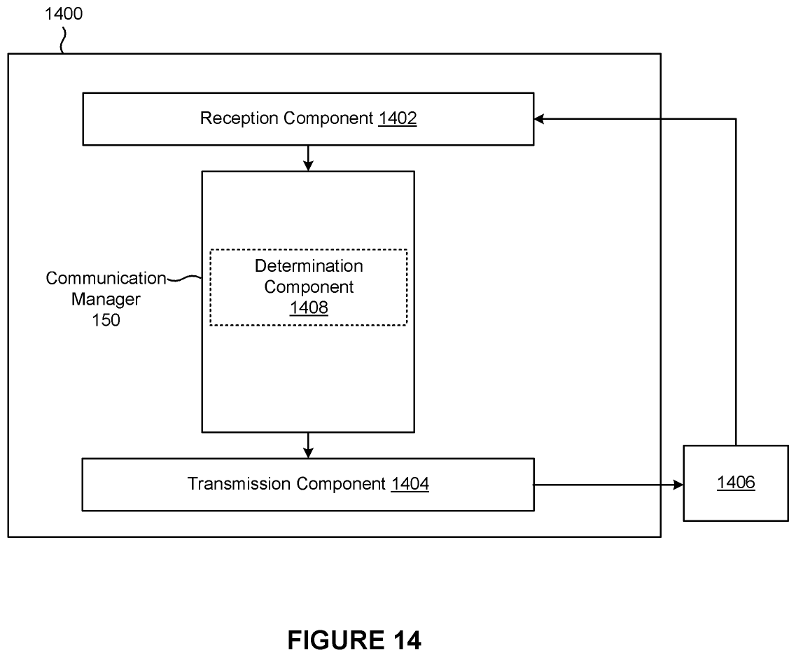

As shown in FIG. 12, in some aspects, process 1200 may include transmitting, to a UE, a configuration of a plurality of BFD-RS sets for a group of cells (block 1210). For example, the network node (such as by using communication manager 150 or transmission component 1404, depicted in FIG. 14) may transmit, to a UE, a configuration of a plurality of BFD-RS sets for a group of cells, as described above.

As further shown in FIG. 12, in some aspects, process 1200 may include transmitting, to the UE, a cell group BFD-RS activation MAC-CE that activates one or more BFD-RSs, of the plurality of BFD-RS sets, for one or more cells in the group of cells (block 1220). For example, the network node (such as by using communication manager 150 or transmission component 1404, depicted in FIG. 14) may transmit, to the UE, a cell group BFD-RS activation MAC-CE that activates one or more BFD-RSs, of the plurality of BFD-RS sets, for one or more cells in the group of cells, as described above.

Process 1200 may include additional aspects, such as any single aspect or any combination of aspects described below or in connection with one or more other processes described elsewhere herein.

In a first additional aspect, the configuration identifies, for each cell in the group of cells, one or more respective BFD-RS sets, of the plurality of BFD-RS sets, associated with the cell.

In a second additional aspect, alone or in combination with the first aspect, the cell group BFD-RS activation MAC-CE includes a set of cell indicator fields including a respective cell indicator field for each cell in the group of cells, each cell indicator field, in the set of cell indicator fields, indicating whether at least one BFD-RS is activated for the respective cell.

In a third additional aspect, alone or in combination with one or more of the first and second aspects, each cell indicator field in the set of cell indicator fields includes a first value that indicates that at least one BFD-RS is activated for the respective cell or a second value that indicates that no BFD-RS is activated for the respective cell.

In a fourth additional aspect, alone or in combination with one or more of the first through third aspects, the cell group BFD-RS activation MAC-CE further includes, for each cell, in the group of cells, for which the respective cell indicator field indicates that at least one BFD-RS is activated, a respective set of BFD-RS indicator fields that includes at least one respective BFD-RS indicator field for each of the one or more BFD-RS sets associated with the cell, each BFD-RS indicator field identifying a respective BFD-RS activated for the cell.

In a fifth additional aspect, alone or in combination with one or more of the first through fourth aspects, for each cell in the group of cells, the one or more BFD-RSs sets associated with the cell include a first BFD-RS set associated with the cell and a second BFD-RS set associated with the cell, and, for each cell, in the group of cells, for which the respective cell indicator field indicates that at least one BFD-RS is activated, the respective set of BFD-RS indicator fields includes a first BFD-RS indicator field that indicates a first BFD-RS of the first BFD-RS set, a second BFD-RS indicator field that indicates a second BFD-RS of the first BFD-RS set, a third BFD-RS indicator field that indicates a third BFD-RS of the second BFD-RS set, and a fourth BFD-RS field that indicates a fourth BFD-RS of the second BFD-RS set.

In a sixth additional aspect, alone or in combination with one or more of the first through fifth aspects, for which the respective cell indicator field indicates that at least one BFD-RS is activated, the respective set of BFD-RS indicator fields includes a respective indication, for each of the first BFD-RS set and the second BFD-RS set, of whether a single BFD-RS of the respective BFD-RS set is activated or two BFD-RSs of the respective BFD-RS set are activated.

In a seventh additional aspect, alone or in combination with one or more of the first through sixth aspects, the cell group BFD-RS activation MAC-CE further includes, for each cell, in the group of cells, for which the respective cell indicator field indicates that at least one BFD-RS is activated, an indication of a respective BFD-RS configuration identifier that indicates a combination of one or more BFD-RSs, of the one or more BFD-RS sets associated with the cell, that are activated for the cell.

In an eighth additional aspect, alone or in combination with one or more of the first through seventh aspects, alone or in combination with one or more of the first through fifth aspects, the configuration indicates, for each cell in the group of cells, one or more combinations of BFD-RSs, of the one or more BFD-RS sets associated with the cell, that are configured for the cell, and, for each cell, in the group of cells, for which the respective cell indicator field indicates that at least one BFD-RS is activated, the respective BFD-RS configuration identifier corresponds to a combination of BFD-RSs of the one or more combinations of BFD-RSs that are configured for the cell.

In a ninth additional aspect, alone or in combination with one or more of the first through eighth aspects, the configuration includes, for each combination of the one or more combinations of BFD-RSs that are configured for each cell in the group of cells, indications of multiple BFD-RS sets of the plurality of BFD-RS sets and indications of one or more BFD-RSs, in each of the multiple BFD-RS sets, that are included in the combination.

In a tenth additional aspect, alone or in combination with one or more of the first through ninth aspects, the configuration includes, for a reference cell of the group of cells, configuration information that indicates BFD-RS sets, of the plurality of BFD-RS sets, and BFD-RSs for a reference combination of BFD-RSs that is configured for the reference cell, and the configuration includes, for each cell, other than the reference cell, of the group of cells, respective configuration information that indicates one or more respective differences between each of the one or more combinations of BFD-RSs that are configured for the cell and the reference combination of BFD-RSs that is configured for the reference cell.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication that supports group level BFD-RS activation in accordance with the present disclosure. The apparatus 1300 may be a UE, or a UE may include the apparatus 1300. In some aspects, the apparatus 1300 includes a reception component 1302, a transmission component 1304, and a communication manager 140, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to perform one or more operations described herein in connection with FIGS. 7-10. Additionally or alternatively, the apparatus 1300 may be configured to perform one or more processes described herein, such as process 1100 of FIG. 11, or a combination thereof. In some aspects, the apparatus 1300 may include one or more components of the UE described above in connection with FIG. 2.

The reception component 1302 may receive communications, such as reference signals, control information, data communications, or a combination thereof, from the apparatus 1306. The reception component 1302 may provide received communications to one or more other components of the apparatus 1300, such as the communication manager 140. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, a memory, or a combination thereof, of the UE described above in connection with FIG. 2.

The transmission component 1304 may transmit communications, such as reference signals, control information, data communications, or a combination thereof, to the apparatus 1306. In some aspects, the communication manager 140 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described above in connection with FIG. 2. In some aspects, the transmission component 1304 may be co-located with the reception component 1302 in a transceiver.

The communication manager 140 may receive or may cause the reception component 1302 to receive, from a network node, a configuration of a plurality of BFD-RS sets for a group of cells. The communication manager 140 may receive or may cause the reception component 1302 to receive, from the network node, a cell group BFD-RS activation MAC-CE that activates one or more BFD-RSs, of the plurality of BFD-RS sets, for one or more cells in the group of cells. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a BFD component 1308, or a combination thereof. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive, from a network node, a configuration of a plurality of BFD-RS sets for a group of cells. The reception component 1302 may receive, from the network node, a cell group BFD-RS activation MAC-CE that activates one or more BFD-RSs, of the plurality of BFD-RS sets, for one or more cells in the group of cells.

The BFD component 1308 may perform beam failure detection based at least in part on the one or more BFD-RSs activated for the one or more cells in the group of cells.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication that supports group level BFD-RS activation in accordance with the present disclosure. The apparatus 1400 may be a network node, or a network node may include the apparatus 1400. In some aspects, the apparatus 1400 includes a reception component 1402, a transmission component 1404, and a communication manager 150, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to perform one or more operations described herein in connection with FIGS. 7-10. Additionally or alternatively, the apparatus 1400 may be configured to perform one or more processes described herein, such as process 1200 of FIG. 12, or a combination thereof. In some aspects, the apparatus 1400 may include one or more components of the network node described above in connection with FIG. 2.

The reception component 1402 may receive communications, such as reference signals, control information, data communications, or a combination thereof, from the apparatus 1406. The reception component 1402 may provide received communications to one or more other components of the apparatus 1400, such as the communication manager 150. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, a memory, or a combination thereof, of the network node described above in connection with FIG. 2.

The transmission component 1404 may transmit communications, such as reference signals, control information, data communications, or a combination thereof, to the apparatus 1406. In some aspects, the communication manager 150 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described above in connection with FIG. 2. In some aspects, the transmission component 1404 may be co-located with the reception component 1402 in a transceiver.

The communication manager 150 may transmit or may cause the transmission component 1404 to transmit, to a UE, a configuration of a plurality of BFD-RS sets for a group of cells. The communication manager 150 may transmit or may cause the transmission component 1404 to transmit, to the UE, a cell group BFD-RS activation MAC-CE that activates one or more BFD-RSs, of the plurality of BFD-RS sets, for one or more cells in the group of cells. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the network node described above in connection with FIG. 2. In some aspects, the communication manager 150 includes a set of components, such as a determination component 1408, or a combination thereof. Alternatively, the set of components may be separate and distinct from the communication manager 150. In some aspects, one or more components of the set of components may include or may be implemented within a controller/processor, a memory, a scheduler, a communication unit, or a combination thereof, of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1404 may transmit, to a UE, a configuration of a plurality of BFD-RS sets for a group of cells. The transmission component 1404 may transmit, to the UE, a cell group BFD-RS activation MAC-CE that activates one or more BFD-RSs, of the plurality of BFD-RS sets, for one or more cells in the group of cells.

The determination component 1408 may determine the configuration of the plurality of BFD-RS sets for the group of cells or the one or BFD-RSs activated for the one or more cells in the group of cells.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a network node, a configuration of a plurality of beam failure detection reference signal (BFD-RS) sets for a group of cells; and receiving, from the network node, a cell group BFD-RS activation medium access control (MAC) control element (MAC-CE) that activates one or more BFD-RSs, of the plurality of BFD-RS sets, for one or more cells in the group of cells.

Aspect 2: The method of Aspect 1, wherein the configuration identifies, for each cell in the group of cells, one or more respective BFD-RS sets, of the plurality of BFD-RS sets, associated with the cell.

Aspect 3: The method of Aspect 2, wherein the cell group BFD-RS activation MAC-CE includes a set of cell indicator fields including a respective cell indicator field for each cell in the group of cells, each cell indicator field, in the set of cell indicator fields, indicating whether at least one BFD-RS is activated for the respective cell.

Aspect 4: The method of Aspect 3, wherein each cell indicator field in the set of cell indicator fields includes a first value that indicates that at least one BFD-RS is activated for the respective cell or a second value that indicates that no BFD-RS is activated for the respective cell.

Aspect 5: The method of any of Aspects 3-4, wherein the cell group BFD-RS activation MAC-CE further includes, for each cell, in the group of cells, for which the respective cell indicator field indicates that at least one BFD-RS is activated, a respective set of BFD-RS indicator fields that includes at least one respective BFD-RS indicator field for each of the one or more BFD-RS sets associated with the cell, each BFD-RS indicator field identifying a respective BFD-RS activated for the cell.

Aspect 6: The method of Aspect 5, wherein, for each cell in the group of cells, the one or more BFD-RSs sets associated with the cell include a first BFD-RS set associated with the cell and a second BFD-RS set associated with the cell, and wherein, for each cell, in the group of cells, for which the respective cell indicator field indicates that at least one BFD-RS is activated, the respective set of BFD-RS indicator fields includes a first BFD-RS indicator field that indicates a first BFD-RS of the first BFD-RS set, a second BFD-RS indicator field that indicates a second BFD-RS of the first BFD-RS set, a third BFD-RS indicator field that indicates a third BFD-RS of the second BFD-RS set, and a fourth BFD-RS field that indicates a fourth BFD-RS of the second BFD-RS set.

Aspect 7: The method of Aspect 6, wherein, for each cell, in the group of cells, for which the respective cell indicator field indicates that at least one BFD-RS is activated, the respective set of BFD-RS indicator fields includes a respective indication, for each of the first BFD-RS set and the second BFD-RS set, of whether a single BFD-RS of the respective BFD-RS set is activated or two BFD-RSs of the respective BFD-RS set are activated.

Aspect 8: The method of any of Aspects 3-4, wherein the cell group BFD-RS activation MAC-CE further includes, for each cell, in the group of cells, for which the respective cell indicator field indicates that at least one BFD-RS is activated, an indication of a respective BFD-RS configuration identifier that indicates a combination of one or more BFD-RSs, of the one or more BFD-RS sets associated with the cell, that are activated for the cell.

Aspect 9: The method of Aspect 8, wherein the configuration indicates, for each cell in the group of cells, one or more combinations of BFD-RSs, of the one or more BFD-RS sets associated with the cell, that are configured for the cell, and wherein, for each cell, in the group of cells, for which the respective cell indicator field indicates that at least one BFD-RS is activated, the respective BFD-RS configuration identifier corresponds to a combination of BFD-RSs of the one or more combinations of BFD-RSs that are configured for the cell.

Aspect 10: The method of Aspect 9, wherein the configuration includes, for each combination of the one or more combinations of BFD-RSs that are configured for each cell in the group of cells, indications of multiple BFD-RS sets of the plurality of BFD-RS sets and indications of one or more BFD-RSs, in each of the multiple BFD-RS sets, that are included in the combination.

Aspect 11: The method of Aspect 9, wherein the configuration includes, for a reference cell of the group of cells, configuration information that indicates BFD-RS sets, of the plurality of BFD-RS sets, and BFD-RSs for a reference combination of BFD-RSs that is configured for the reference cell, and wherein the configuration includes, for each cell, other than the reference cell, of the group of cells, respective configuration information that indicates one or more respective differences between each of the one or more combinations of BFD-RSs that are configured for the cell and the reference combination of BFD-RSs that is configured for the reference cell.

Aspect 12: The method of any of Aspects 1-11, further comprising: performing beam failure detection based at least in part on the one or more BFD-RSs activated for the one or more cells in the group of cells.

Aspect 13: A method of wireless communication performed by a network node, comprising: transmitting, to a user equipment (UE), a configuration of a plurality of beam failure detection reference signal (BFD-RS) sets for a group of cells; and transmitting, to the UE, a cell group BFD-RS activation medium access control (MAC) control element (MAC-CE) that activates one or more BFD-RSs, of the plurality of BFD-RS sets, for one or more cells in the group of cells.

Aspect 14: The method of Aspect 13, wherein the configuration identifies, for each cell in the group of cells, one or more respective BFD-RS sets, of the plurality of BFD-RS sets, associated with the cell.

Aspect 15: The method of Aspect 14, wherein the cell group BFD-RS activation MAC-CE includes a set of cell indicator fields including a respective cell indicator field for each cell in the group of cells, each cell indicator field, in the set of cell indicator fields, indicating whether at least one BFD-RS is activated for the respective cell.

Aspect 16: The method of Aspect 15, wherein each cell indicator field in the set of cell indicator fields includes a first value that indicates that at least one BFD-RS is activated for the respective cell or a second value that indicates that no BFD-RS is activated for the respective cell.

Aspect 17: The method of any of Aspects 15-16, wherein the cell group BFD-RS activation MAC-CE further includes, for each cell, in the group of cells, for which the respective cell indicator field indicates that at least one BFD-RS is activated, a respective set of BFD-RS indicator fields that includes at least one respective BFD-RS indicator field for each of the one or more BFD-RS sets associated with the cell, each BFD-RS indicator field identifying a respective BFD-RS activated for the cell.

Aspect 18: The method of Aspect 17, wherein, for each cell in the group of cells, the one or more BFD-RSs sets associated with the cell include a first BFD-RS set associated with the cell and a second BFD-RS set associated with the cell, and wherein, for each cell, in the group of cells, for which the respective cell indicator field indicates that at least one BFD-RS is activated, the respective set of BFD-RS indicator fields includes a first BFD-RS indicator field that indicates a first BFD-RS of the first BFD-RS set, a second BFD-RS indicator field that indicates a second BFD-RS of the first BFD-RS set, a third BFD-RS indicator field that indicates a third BFD-RS of the second BFD-RS set, and a fourth BFD-RS field that indicates a fourth BFD-RS of the second BFD-RS set.

Aspect 19: The method of Aspect 18, wherein, for each cell, in the group of cells, for which the respective cell indicator field indicates that at least one BFD-RS is activated, the respective set of BFD-RS indicator fields includes a respective indication, for each of the first BFD-RS set and the second BFD-RS set, of whether a single BFD-RS of the respective BFD-RS set is activated or two BFD-RSs of the respective BFD-RS set are activated.

Aspect 20: The method of any of Aspects 15-16, wherein the cell group BFD-RS activation MAC-CE further includes, for each cell, in the group of cells, for which the respective cell indicator field indicates that at least one BFD-RS is activated, an indication of a respective BFD-RS configuration identifier that indicates a combination of one or more BFD-RSs, of the one or more BFD-RS sets associated with the cell, that are activated for the cell.

Aspect 21: The method of Aspect 20, wherein the configuration indicates, for each cell in the group of cells, one or more combinations of BFD-RSs, of the one or more BFD-RS sets associated with the cell, that are configured for the cell, and wherein, for each cell, in the group of cells, for which the respective cell indicator field indicates that at least one BFD-RS is activated, the respective BFD-RS configuration identifier corresponds to a combination of BFD-RSs of the one or more combinations of BFD-RSs that are configured for the cell.

Aspect 22: The method of Aspect 21, wherein the configuration includes, for each combination of the one or more combinations of BFD-RSs that are configured for each cell in the group of cells, indications of multiple BFD-RS sets of the plurality of BFD-RS sets and indications of one or more BFD-RSs, in each of the multiple BFD-RS sets, that are included in the combination.

Aspect 23: The method of Aspect 21, wherein the configuration includes, for a reference cell of the group of cells, configuration information that indicates BFD-RS sets, of the plurality of BFD-RS sets, and BFD-RSs for a reference combination of BFD-RSs that is configured for the reference cell, and wherein the configuration includes, for each cell, other than the reference cell, of the group of cells, respective configuration information that indicates one or more respective differences between each of the one or more combinations of BFD-RSs that are configured for the cell and the reference combination of BFD-RSs that is configured for the reference cell.

Aspect 24: An apparatus for wireless communication at a device, comprising a processor; memory coupled with the processor; and instructions stored in the memory and executable by the processor to cause the apparatus to perform the method of one or more of Aspects 1-12.

Aspect 25: A device for wireless communication, comprising a memory and one or more processors coupled to the memory, the one or more processors configured to perform the method of one or more of Aspects 1-12.

Aspect 26: An apparatus for wireless communication, comprising at least one means for performing the method of one or more of Aspects 1-12.

Aspect 27: A non-transitory computer-readable medium storing code for wireless communication, the code comprising instructions executable by a processor to perform the method of one or more of Aspects 1-12.

Aspect 28: A non-transitory computer-readable medium storing a set of instructions for wireless communication, the set of instructions comprising one or more instructions that, when executed by one or more processors of a device, cause the device to perform the method of one or more of Aspects 1-12.

Aspect 29: An apparatus for wireless communication at a device, comprising a processor; memory coupled with the processor; and instructions stored in the memory and executable by the processor to cause the apparatus to perform the method of one or more of Aspects 13-23.

Aspect 30: A device for wireless communication, comprising a memory and one or more processors coupled to the memory, the one or more processors configured to perform the method of one or more of Aspects 13-23.

Aspect 31: An apparatus for wireless communication, comprising at least one means for performing the method of one or more of Aspects 13-23.

Aspect 32: A non-transitory computer-readable medium storing code for wireless communication, the code comprising instructions executable by a processor to perform the method of one or more of Aspects 13-23.

Aspect 33: A non-transitory computer-readable medium storing a set of instructions for wireless communication, the set of instructions comprising one or more instructions that, when executed by one or more processors of a device, cause the device to perform the method of one or more of Aspects 13-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one memory; and
at least one processor communicatively coupled with the at least one memory, the at least one processor configured to cause the UE to:
receive, from a network node, a configuration of a plurality of beam failure detection reference signal (BFD-RS) sets for a group of cells; and
receive, from the network node, a cell group BFD-RS activation medium access control (MAC) control element (MAC-CE) that activates one or more BFD-RSs, of the plurality of BFD-RS sets, for one or more cells in the group of cells.

2. The UE of claim 1, wherein the configuration identifies, for each cell in the group of cells, one or more respective BFD-RS sets, of the plurality of BFD-RS sets, associated with the cell.

3. The UE of claim 2, wherein the cell group BFD-RS activation MAC-CE includes a set of cell indicator fields including a respective cell indicator field for each cell in the group of cells, each cell indicator field, in the set of cell indicator fields, indicating whether at least one BFD-RS is activated for the respective cell.

4. The UE of claim 3, wherein each cell indicator field in the set of cell indicator fields includes a first value that indicates that at least one BFD-RS is activated for the respective cell or a second value that indicates that no BFD-RS is activated for the respective cell.

5. The UE of claim 3, wherein the cell group BFD-RS activation MAC-CE further includes, for each cell, in the group of cells, for which the respective cell indicator field indicates that at least one BFD-RS is activated, a respective set of BFD-RS indicator fields that includes at least one respective BFD-RS indicator field for each of the one or more BFD-RS sets associated with the cell, each BFD-RS indicator field identifying a respective BFD-RS activated for the cell.

6. The UE of claim 5, wherein, for each cell in the group of cells, the one or more BFD-RSs sets associated with the cell include a first BFD-RS set associated with the cell and a second BFD-RS set associated with the cell, and wherein, for each cell, in the group of cells, for which the respective cell indicator field indicates that at least one BFD-RS is activated, the respective set of BFD-RS indicator fields includes a first BFD-RS indicator field that indicates a first BFD-RS of the first BFD-RS set, a second BFD-RS indicator field that indicates a second BFD-RS of the first BFD-RS set, a third BFD-RS indicator field that indicates a third BFD-RS of the second BFD-RS set, and a fourth BFD-RS field that indicates a fourth BFD-RS of the second BFD-RS set.

7. The UE of claim 6, wherein, for each cell, in the group of cells, for which the respective cell indicator field indicates that at least one BFD-RS is activated, the respective set of BFD-RS indicator fields includes a respective indication, for each of the first BFD-RS set and the second BFD-RS set, of whether a single BFD-RS of the respective BFD-RS set is activated or two BFD-RSs of the respective BFD-RS set are activated.

8. The UE of claim 3, wherein the cell group BFD-RS activation MAC-CE further includes, for each cell, in the group of cells, for which the respective cell indicator field indicates that at least one BFD-RS is activated, an indication of a respective BFD-RS configuration identifier that indicates a combination of one or more BFD-RSs, of the one or more BFD-RS sets associated with the cell, that are activated for the cell.

9. The UE of claim 8, wherein the configuration indicates, for each cell in the group of cells, one or more combinations of BFD-RSs, of the one or more BFD-RS sets associated with the cell, that are configured for the cell, and wherein, for each cell, in the group of cells, for which the respective cell indicator field indicates that at least one BFD-RS is activated, the respective BFD-RS configuration identifier corresponds to a combination of BFD-RSs of the one or more combinations of BFD-RSs that are configured for the cell.

10. The UE of claim 9, wherein the configuration includes, for each combination of the one or more combinations of BFD-RSs that are configured for each cell in the group of cells, indications of multiple BFD-RS sets of the plurality of BFD-RS sets and indications of one or more BFD-RSs, in each of the multiple BFD-RS sets, that are included in the combination.

11. The UE of claim 9, wherein the configuration includes, for a reference cell of the group of cells, configuration information that indicates BFD-RS sets, of the plurality of BFD-RS sets, and BFD-RSs for a reference combination of BFD-RSs that is configured for the reference cell, and wherein the configuration includes, for each cell, other than the reference cell, of the group of cells, respective configuration information that indicates one or more respective differences between each of the one or more combinations of BFD-RSs that are configured for the cell and the reference combination of BFD-RSs that is configured for the reference cell.

12. The UE of claim 1, wherein the at least one processor is further configured to cause the UE to:
perform beam failure detection based at least in part on the one or more BFD-RSs activated for the one or more cells in the group of cells.

13. A network node for wireless communication, comprising:
at least one memory; and
at least one processor communicatively coupled with the at least one memory, the at least one processor configured to cause the network node to:
transmit, to a user equipment (UE), a configuration of a plurality of beam failure detection reference signal (BFD-RS) sets for a group of cells; and
transmit, to the UE, a cell group BFD-RS activation medium access control (MAC) control element (MAC-CE) that activates one or more BFD-RSs, of the plurality of BFD-RS sets, for one or more cells in the group of cells.

14. The network node of claim 13, wherein the configuration identifies, for each cell in the group of cells, one or more respective BFD-RS sets, of the plurality of BFD-RS sets, associated with the cell.

15. The network node of claim 14, wherein the cell group BFD-RS activation MAC-CE includes a set of cell indicator fields including a respective cell indicator field for each cell in the group of cells, each cell indicator field, in the set of cell indicator fields, indicating whether at least one BFD-RS is activated for the respective cell.

16. The network node of claim 15, wherein each cell indicator field in the set of cell indicator fields includes a first value that indicates that at least one BFD-RS is activated for the respective cell or a second value that indicates that no BFD-RS is activated for the respective cell.

17. The network node of claim 15, wherein the cell group BFD-RS activation MAC-CE further includes, for each cell, in the group of cells, for which the respective cell indicator field indicates that at least one BFD-RS is activated, a respective set of BFD-RS indicator fields that includes at least one respective BFD-RS indicator field for each of the one or more BFD-RS sets associated with the cell, each BFD-RS indicator field identifying a respective BFD-RS activated for the cell.

18. The network node of claim 17, wherein, for each cell in the group of cells, the one or more BFD-RSs sets associated with the cell include a first BFD-RS set associated with the cell and a second BFD-RS set associated with the cell, and wherein, for each cell, in the group of cells, for which the respective cell indicator field indicates that at least one BFD-RS is activated, the respective set of BFD-RS indicator fields includes a first BFD-RS indicator field that indicates a first BFD-RS of the first BFD-RS set, a second BFD-RS indicator field that indicates a second BFD-RS of the first BFD-RS set, a third BFD-RS indicator field that indicates a third BFD-RS of the second BFD-RS set, and a fourth BFD-RS field that indicates a fourth BFD-RS of the second BFD-RS set.

19. The network node of claim 18, wherein, for each cell, in the group of cells, for which the respective cell indicator field indicates that at least one BFD-RS is activated, the respective set of BFD-RS indicator fields includes a respective indication, for each of the first BFD-RS set and the second BFD-RS set, of whether a single BFD-RS of the respective BFD-RS set is activated or two BFD-RSs of the respective BFD-RS set are activated.

20. The network node of claim 15, wherein the cell group BFD-RS activation MAC-CE further includes, for each cell, in the group of cells, for which the respective cell indicator field indicates that at least one BFD-RS is activated, an indication of a respective BFD-RS configuration identifier that indicates a combination of one or more BFD-RSs, of the one or more BFD-RS sets associated with the cell, that are activated for the cell.

21. The network node of claim 20, wherein the configuration indicates, for each cell in the group of cells, one or more combinations of BFD-RSs, of the one or more BFD-RS sets associated with the cell, that are configured for the cell, and wherein, for each cell, in the group of cells, for which the respective cell indicator field indicates that at least one BFD-RS is activated, the respective BFD-RS configuration identifier corresponds to a combination of BFD-RSs of the one or more combinations of BFD-RSs that are configured for the cell.

22. The network node of claim 21, wherein the configuration includes, for each combination of the one or more combinations of BFD-RSs that are configured for each cell in the group of cells, indications of multiple BFD-RS sets of the plurality of BFD-RS sets and indications of one or more BFD-RSs, in each of the multiple BFD-RS sets, that are included in the combination.

23. The network node of claim 21, wherein the configuration includes, for a reference cell of the group of cells, configuration information that indicates BFD-RS sets, of the plurality of BFD-RS sets, and BFD-RSs for a reference combination of BFD-RSs that is configured for the reference cell, and wherein the configuration includes, for each cell, other than the reference cell, of the group of cells, respective configuration information that indicates one or more respective differences between each of the one or more combinations of BFD-RSs that are configured for the cell and the reference combination of BFD-RSs that is configured for the reference cell.

24. A method of wireless communication performed by a user equipment (UE), comprising:
receiving, from a network node, a configuration of a plurality of beam failure detection reference signal (BFD-RS) sets for a group of cells; and
receiving, from the network node, a cell group BFD-RS activation medium access control (MAC) control element (MAC-CE) that activates one or more BFD-RSs, of the plurality of BFD-RS sets, for one or more cells in the group of cells.

25. The method of claim 24, wherein the configuration identifies, for each cell in the group of cells, one or more respective BFD-RS sets, of the plurality of BFD-RS sets, associated with the cell.

26. The method of claim 25, wherein the cell group BFD-RS activation MAC-CE includes a set of cell indicator fields including a respective cell indicator field for each cell in the group of cells, each cell indicator field, in the set of cell indicator fields, indicating whether at least one BFD-RS is activated for the respective cell.

27. The method of claim 26, wherein the cell group BFD-RS activation MAC-CE further includes, for each cell, in the group of cells, for which the respective cell indicator field indicates that at least one BFD-RS is activated, a respective set of BFD-RS indicator fields that includes at least one respective BFD-RS indicator field for each of the one or more BFD-RS sets associated with the cell, each BFD-RS indicator field identifying a respective BFD-RS activated for the cell.

28. The method of claim 27, wherein, for each cell in the group of cells, the one or more BFD-RSs sets associated with the cell include a first BFD-RS set associated with the cell and a second BFD-RS set associated with the cell, and wherein, for each cell, in the group of cells, for which the respective cell indicator field indicates that at least one BFD-RS is activated, the respective set of BFD-RS indicator fields includes a first BFD-RS indicator field that indicates a first BFD-RS of the first BFD-RS set, a second BFD-RS indicator field that indicates a second BFD-RS of the first BFD-RS set, a third BFD-RS indicator field that indicates a third BFD-RS of the second BFD-RS set, and a fourth BFD-RS field that indicates a fourth BFD-RS of the second BFD-RS set.

29. The method of claim 26, wherein the cell group BFD-RS activation MAC-CE further includes, for each cell, in the group of cells, for which the respective cell indicator field indicates that at least one BFD-RS is activated, an indication of a respective BFD-RS configuration identifier that indicates a combination of one or more BFD-RSs, of the one or more BFD-RS sets associated with the cell, that are activated for the cell.

30. A method of wireless communication performed by a network node, comprising:
transmitting, to a user equipment (UE), a configuration of a plurality of beam failure detection reference signal (BFD-RS) sets for a group of cells; and
transmitting, to the UE, a cell group BFD-RS activation medium access control (MAC) control element (MAC-CE) that activates one or more BFD-RSs, of the plurality of BFD-RS sets, for one or more cells in the group of cells.
